(19) United States
(12) Patent Application Publication
(10) Pub. No.: US 2011/0314053 A1
(43) Pub. Date: Dec. 22, 2011

(54) PRESENTATION SUPPORT DEVICE AND COMPUTER READABLE MEDIUM

(75) Inventors: Takeshi MORIKAWA, Takarazuka-shi (JP); Keisuke Teramoto, Itami-shi (JP); Atsushi Ohshima, Amagasaki-shi (JP); Akihiro Torigoshi, Amagasaki-shi (JP); Masami Yamada, Sennan-gun (JP)

(73) Assignee: Konica Minolta Business Technologies, Inc., Chiyoda-ku (JP)

(21) Appl. No.: 13/158,503

(22) Filed: Jun. 13, 2011

(30) Foreign Application Priority Data
Jun. 21, 2010 (JP) 2010-140324

(51) Int. Cl. G06F 3/01; G06F 17/30

(52) U.S. Cl. 707/769; 715/730; 707/E17.014

(57) ABSTRACT

A presentation support device, comprises: a storage part for storing the presentation data and search filter information in which a keyword to specify the content of the presentation is registered; a data projection part for reading the presentation data in the storage part and causes the presentation data to be projected; a data distribution part for causing the information processing terminal to display the presentation data; and an answer generation part for obtaining an answer to a request on question toward the presentation and generating answer information in response to the request on question. The answer generation part reads the keyword registered in the search filter information and searches a predetermined database by a combination of the read keyword and a search keyword contained in the request on question, thereby obtaining the answer to the request on question and generating the answer information when the request on question is received.

This application is based on the application No. 2010-140324 filed in Japan, the contents of which are hereby incorporated by reference.

### BACKGROUND OF THE INVENTION

1. Field of the Invention

The present invention relates to a presentation support device and a computer readable medium, and more particularly, to the presentation support device which is capable of performing data communication with each of a first information processing device operable for a presenter, a second information processing device operable for an audience who sees and listens to a presentation by the presenter and a projector which projects presentation data.

2. Description of the Background Art

A device which includes, for example, an audience terminal with which an audience is allowed to enter information of his or her own will. The information entered by the audience is then analyzed by an audience information analysis part, and information reflects the mind of the audience is extracted. The extracted information is displayed with visual presentation on a screen of a terminal for a presenter. So, the device is capable of providing information to easily read the mind of the audience to the presenter and supporting to give a fascinating presentation. The device is known as one type of presentation support devices that support the presentation by the presenter. This known technique is introduced for example in Japanese Patent Application Laid-Open No. JP7(1995)-200440 A.

When, for example, a term the audience is not familiar with is used in the presentation by the presenter, the presentation is not fully understandable for the audience seeing and listening to the presentation. To make inquiries during the presentation by the audience may temporarily interrupt the presentation and impair efficiency of the presentation.

In order to avoid the inferior efficiency of the presentation, the conventional audience brings his or her own information processing terminal (such as PC) for the presentation. The audience with his or her information processing terminal goes on an internet and others and searches, for example, for meaning of the term through a general search engine.

If the individual audience searches through the general search engine by his or her own, too many web pages matching a search keyword are found. The audience needs to find an answer suitable on the content of the presentation from many web pages by him or herself. It is difficult to receive the answer suitable on the content of the presentation effectively in a short time. So, the audience may not concentrate on seeing and listening to the presentation by the presenter.

### SUMMARY OF THE INVENTION

The present invention is intended to solve the above problems. Thus, the present invention is intended to provide a presentation support device and a computer readable medium capable of allowing a question on the content of a presentation asked by an audience to be solved easily and efficiently during the presentation. Therefore, the presentation support device and the computer readable medium are capable of allowing the depth of the audience's understanding of the presentation to be increased.

First, the present invention is directed to a presentation support device capable of performing data communication with each of a first information processing terminal operable for a presenter, a second information processing terminal operable for an audience who sees and listens to a presentation by the presenter and a projector projects presentation data.

According to one aspect of the presentation support device, the presentation support device, comprises: a storage part for storing therein the presentation data created in advance by the presenter and search filter information in which a keyword to specify the content of the presentation is registered; a data projection part for reading the presentation data in the storage part and outputting the read presentation data to the projector in response to an instruction received from the first information processing terminal, thereby causing the projector to project the presentation data; a data distribution part for causing the second information processing terminal to display the presentation data by reading the presentation data in the storage part and outputting the read presentation data to the second information processing terminal; and an answer generation part for obtaining an answer to a request on question toward the presentation asked by the audience and generating answer information in response to the request on question received from the second information processing terminal. The answer generation part reads the keyword registered in the search filter information and searches a predetermined database by a combination of the read keyword and a search keyword contained in the request on question, thereby obtaining the answer to the request on question and generating the answer information when the request on question is received from the second information processing terminal.

According to another aspect of the presentation support device, the presentation support device, comprises: a storage part for storing therein the presentation data created in advance by the presenter and answer to question information in which a keyword created in advance by the presenter and an answer corresponding to the keyword associated with each other are registered; a data projection part for reading the presentation data in the storage part and outputting the read presentation data to the projector in response to an instruction received from the first information processing terminal, thereby causing the projector to project the presentation data; a data distribution part for causing the second information processing terminal to display the presentation data by reading the presentation data in the storage part and outputting the read presentation data to the second information processing terminal; and an answer generation part for obtaining an answer to a request on question toward the presentation asked by the audience and generating answer information in response to the request on question received from the second information processing terminal. The answer generation part reads the answer to question information and determines whether or not the keyword matching a search keyword contained in the request on question is registered in the answer to question information when the request on question is received from the second information processing terminal, and obtains the answer corresponding to the search keyword from the answer to question information and generates the answer information as the keyword matching the search keyword is registered.

Second, the present invention is directed to a computer readable medium on which a program is recorded. The program is executed by a computer capable of performing data communication with each of a first information processing terminal operable for a presenter, a second information processing terminal operable for an audience who sees and listens to a presentation by the presenter and a projector projects presentation data.

According to one aspect of the computer readable medium, the program causes the computer to operate as a system comprising: a presentation registration part for registering the presentation data created in advance by the presenter and search filter information in which a keyword to specify the content of the presentation is recorded in a predetermined storage part; a data projection part for reading the presentation data in the storage part and outputting the read presentation data to the projector in response to an instruction received from the first information processing terminal, thereby causing the projector to project the presentation data; a data distribution part for causing the second information processing terminal to display the presentation data by reading the presentation data in the storage part and outputting the read presentation data to the second information processing terminal; and an answer generation part for obtaining an answer to a request on question toward the presentation asked by the audience and generating answer information in response to the request on question received from the second information processing terminal. The answer generation part reads the keyword registered in the search filter information and searches a predetermined database by a combination of the read keyword and a search keyword contained in the request on question, thereby obtaining the answer to the request on question and generating the answer information when the request on question is received from the second information processing terminal.

According to another aspect of the computer readable medium, the program causes the computer to operate as a system comprising: a presentation registration part for registering the presentation data created in advance by the presenter and answer to question information in which a keyword created in advance by the presenter and an answer corresponding to the keyword associated with each other are recorded in a predetermine storage part; a data projection part for reading the presentation data in the storage part and outputting the read presentation data to the projector in response to an instruction received from the first information processing terminal, thereby causing the projector to project the presentation data; a data distribution part for causing the second information processing terminal to display the presentation data by reading the presentation data in the storage part and outputting the read presentation data to the second information processing terminal; and an answer generation part for obtaining an answer to a request on question toward the presentation asked by the audience and generating answer information in response to the request on question received from the second information processing terminal. The answer generation part reads the answer to question information and determines whether or not the keyword matching a search keyword contained in the request on question is registered in the answer to question information when the request on question is received from the second information processing terminal, and obtains the answer corresponding to the search keyword from the answer to question information and generates the answer information if the keyword matching the search keyword is registered.

### BRIEF DESCRIPTION OF THE DRAWINGS

FIG. 1 shows an exemplary configuration of a presentation system;

FIG. 2 is a block diagram showing the internal configuration of an information device making up a presentation support device;

FIG. 3 shows an example of various types of data registered in a presentation box by a presentation registration part;

FIG. 4 is a flow diagram explaining an exemplary process sequence on a presentation registration process executed by a controller of the information device;

FIG. 5 shows an example of presentation data;

FIG. 6 shows an example of answer to question information;

FIG. 7 shows an example of search filter information;

FIG. 8 shows an example of the data configuration of a database;

FIG. 9 shows an example of question and answer mode switching condition information;

FIG. 10 is a flow diagram explaining an exemplary process sequence on a presentation execution process executed by the controller of the information device;

FIG. 11 shows an example of a presentation operation screen displayed on a screen of an information processing terminal of a presenter;

FIG. 12 shows an example of an operation screen displayed on a screen of an information processing terminal of an audience;

FIG. 13 is a flow diagram explaining in detail an exemplary process sequence of a presentation process;

FIG. 14 is a flow diagram explaining in detail an exemplary process sequence of a question and answer process;

FIG. 15 shows an example of an audience request list;

FIG. 16 is a flow diagram explaining in detail an exemplary process sequence of an audience response process;

FIG. 17 is a flow diagram explaining in detail an exemplary process sequence of a request response process;

FIG. 18 is a flow diagram explaining in detail an exemplary process sequence of an answer obtain process;

FIG. 19 is a flow diagram explaining in detail an exemplary process sequence of an answer obtain process;

FIG. 20 shows an example of an operation screen displayed on the screen of the information processing terminal of an audience A;

FIG. 21 shows an example of an operation screen displayed on the information processing terminal of an audience B;

FIG. 22 shows an example of an operation screen displayed on the information processing terminal of the audience C; and

FIG. 23 shows an example of the presentation data to which a request from each audience A, B and C and an answer is reflected.

### DESCRIPTION OF THE PRESENT PREFERRED EMBODIMENTS

A present preferred embodiment of the present invention is described in detail below with reference to figures. In the description given below, those elements which are shared in common among figures are represented by the same reference numerals, and these elements are not discussed repeatedly for the same description.

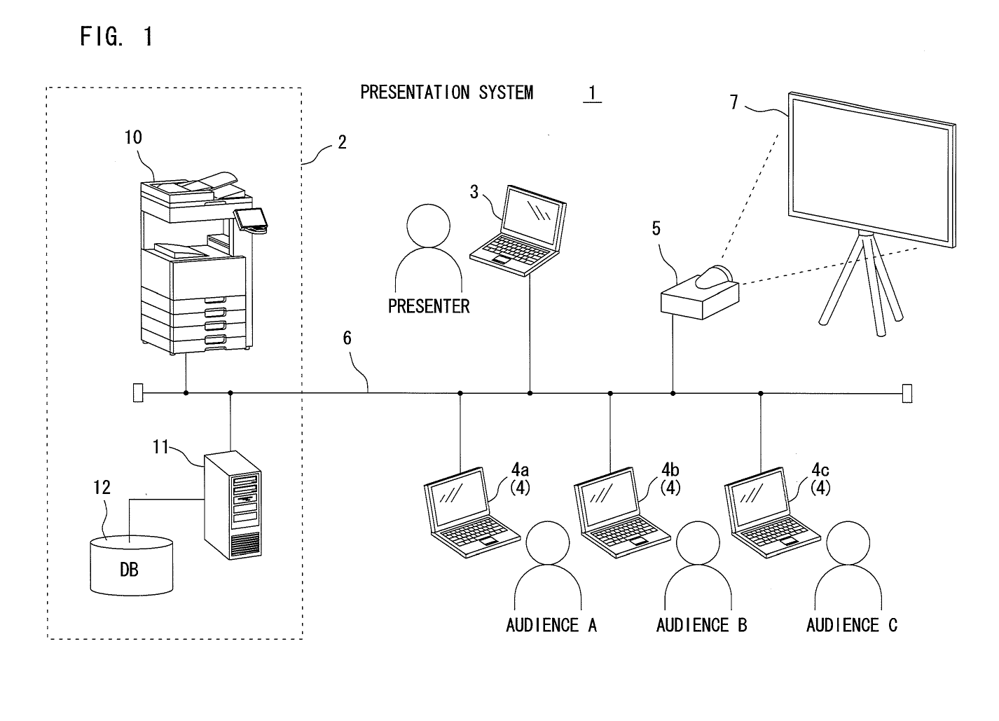

FIG. 1 shows an exemplary configuration of a presentation system 1 of the preferred embodiment. The presentation system 1 includes a presentation support device 2, a first information processing terminal 3 operable for a presenter, at least one second information processing terminal 4 operable for at least one audience who sees and listens to a presentation by the presenter and a projector 5 projects an image of data such as presentation data on a screen 7 to display. These components are connected to each other through a network 6 including a LAN in a manner that allows data communication therebetween.

The presentation support device 2 of the present preferred embodiment includes an information device 10 formed from a device such as MFPs (Multi-functional peripherals) and a search device 11 with a database 12 in which a various types of information is stored. The information device 10 and the search device 11 are connected in a manner that allows data communication with each other through the network 6. The information device 10 and the search device 11 of FIG. 1 are configured to be different devices. The functions of the search device 11 may be incorporated in the information device 10. The projector 5 is a display device which displays the image of data such as presentation data to make the data visible for the presenter and each audience at the same time.

The first information processing terminal 3 operable for the presenter is formed from a generally-used personal computer (PC), while the second information processing terminal 4 operable for the audience is also formed from the generally-used personal computer (PC). According to the present preferred embodiment, there are three audiences A, B and C who see and listen to the presentation by the presenter. The second information processing terminals 4a, 4b and 4c operable for individual audience A, B and C are provided. Each of the information processing terminals 3, 4a, 4b and 4c may have a wired or wireless connection to the network 6.

The information device 10 includes a presentation function besides multiple functions such as a copy function, a scan function and a print function. The information device 10 realizes the main functions of the presentation support device 2. More in detail, the information device 10 stores therein presentation data registered in advance by the presenter. The information device 10 then reads data of one page from the presentation data in response to an instruction of the presenter and outputs the read data to the projector 5, thereby causing the projector 5 to project the presentation data on the screen 7. As execution of the presentation starts, the information device 10 causes the information processing terminal 3 operable for the presenter to display an operation screen for the presenter, while at the same time causing the respective information terminals 4a, 4b and 4c operable for the audiences A, B and C to display an operation screen corresponding to each audience A, B and C.

In response to receipt of a search command from the information device 10 during the execution of the presentation, the search device 11 searches the database 12 based on the search command and outputs a result of the search to the information device 10. The search device 11 and the database 12 of this kind are configured as database system for accumulating technical in-house information and other types of information, for example.

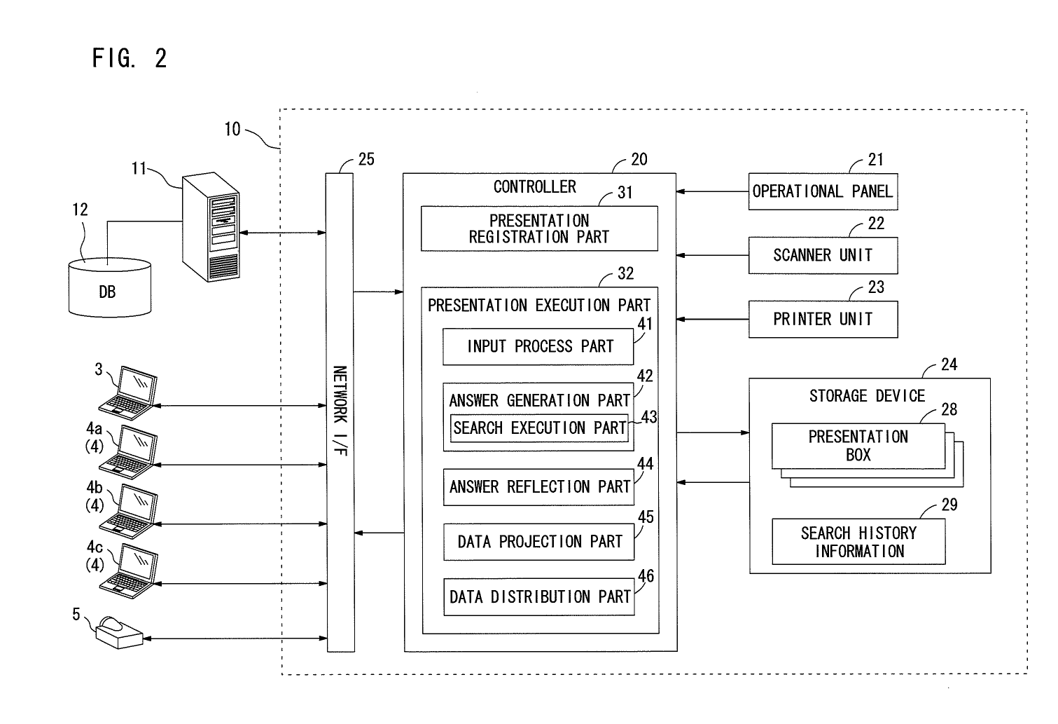

FIG. 2 is a block diagram showing the internal configuration of the information device 10. The information device 10 includes a controller 20, an operational panel 21, a scanner unit 22, a printer unit 23, a storage device 24 and a network interface 25. The controller 20 is for controlling each part. The operational panel 21 is a user interface when the information device 10 is directly operated by a user. The scanner unit 22 reads a document and generates image data, and the printer unit 23 produces a printed matter based on the image data. The storage device 24 is a device such as a hard disk drive. The network interface 25 is for performing data communication with other devices through the network 6. The storage device 24 includes at least one presentation box 28 and search history information 29 that are relating to the presentation, while storing at least one program and various types of data. The presentation box 28 is a dedicated storage region created for each presentation. The various types of data to be referred in execution of the presentation are stored in the corresponding presentation box 28. The search history information 29 is history information in which the previous search results are recorded. The information device 10 outputs the search command to the search device 11, and obtains the search result from the search device 11. As a result, the search history information 29 is information obtained and recorded.

The controller 20 includes a CPU and a memory that are not shown in FIG. 2. The CPU executes a predetermined program stored in a computer readable medium such as the storage device 24, thereby allowing the above-mentioned multiple functions including the copy function, the scan function, the print function and the presentation function to operate. Especially, as allowing the presentation function to operate, the controller 20 functions as a presentation registration part 31 and a presentation execution part 32 as illustrated in FIG. 2.

The presentation registration part 31 registers the presentation with the information device 10. The presenter makes an operation directly to the operational panel 21 or makes a remote operation through the information processing terminal 3, thereby putting the presentation registration part 31 into operation to register the presentation with the information device 10. The presentation registration part 31 creates the presentation box 28 in the storage device 24 for each presentation registered by the presenter. The presentation registration part 31 stores various types of data registered by the presenter in the corresponding presentation box 28.

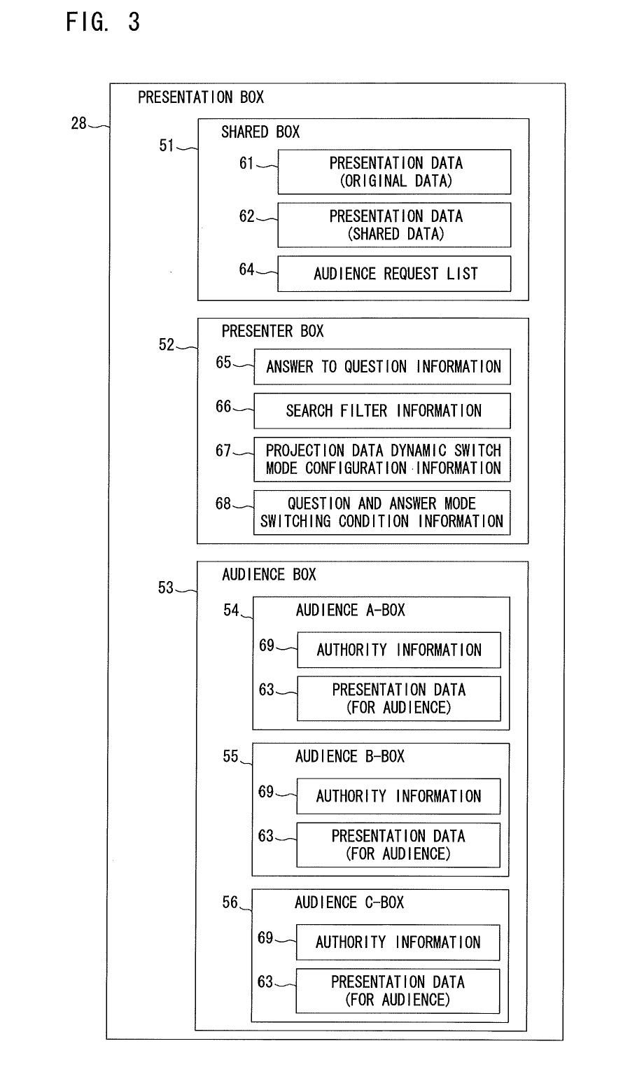

FIG. 3 shows an example of the various types of data registered in the presentation box 28 by the presentation registration part 31. In response to creation of the presentation box 28 corresponding to one presentation, the presentation registration part 31 further creates a shared box 51, a presenter box 52 and an audience box 53 in the box 28. An audience A-box 54, an audience B-box 55 and an audience C-box 56 are further created in the audience box 53 by the presentation registration part 31 as a storage region dedicated to each audience A, B and C registered by the presenter. The shared box 51 shared by the presenter and each audience A, B and C stores information referable for all of the presenter and the audiences A, B and C. The presenter box 52 which is dedicated to the presenter stores information referable or rewritable for only the presenter. The audience A-box 54 is dedicated to the audience A, the audience B-box 55 is dedicated to the audience B and the audience C-box 56 is dedicated to the audience C.

After receiving the presentation data such as a presentation document and material created in advance by the presenter, the presentation registration part 31 generates three types of data as to the received presentation data. The presentation registration part 31 then stores presentation data 61, 62 and 63 corresponding to each type of the data in the presentation box 28. Both of the presentation data 61 and 62 are stored in the shared box 51. The presentation data 61 is original data which has a limitation to restrict rewrite thereof. The presentation data 62 is shared data has no limitation on rewrite, so is rewritable. The presentation data 63 is stored in each of the audience A-box 54, the audience B-box 55 and the audience C-box 56 individually. The presentation data 63 is data for the audience which has no limitation on rewrite, so is rewritable.

The presentation registration part 31 creates an audience request list 64 and stores in the shared box 51 with the creation of the presentation box 28. A request received from each audience A, B and C after the start of the execution of the presentation is registered in the audience request list 64. So, no information is registered in the audience request list 64 at time of the creation of the audience request list 64 in the shared box 51 by the presentation registration part 31. Moreover, in response to receipt of answer to question information 65 and search filter information 66 created in advance by the presenter, the presentation registration part 31 stores them in the presenter box 52. The details of the answer to question information 65 and the search filter information 66 are described later.

The presentation registration part 31 receives operations to set a projection data dynamic switch mode performed by the presenter, and stores information relating to the setting in the presenter box 52 as projection data dynamic switch mode configuration information 67. The projection data dynamic switch mode allows the information device 10 to read data of the page to be projected from the presentation data 62, the shared data and to output when the presentation data is output to the projector 5. When the projection data dynamic switch mode is enabled (hereafter, on), data is projected based on the presentation data 62, the shared data. When the projection data dynamic switch mode is disabled (hereafter, off), data is projected based on the presentation data 61, the original data.

A request for answer to question and an answer to the request are reflected to the presentation data 62, the shared data, under a predetermined condition when the request for answer to the question (hereafter, request on question, or question) is sent from one of the audiences A, B and C during the presentation as described later. In some cases, the audience A, B or C sends the request on question during the presentation. In this case, the request such as the question is shown on the data projected on the screen 7 in response to the request if the projection data dynamic switch mode is on. This results in the presenter and other audiences being able to share the request from one audience at the same time, for example.

Some presenters prefer to concentrate on the presentation until he or she finishes the presentation. It is better for such presenter to have time for answering questions individually asked by the audiences A, B and C or supplementing the information after the presentation. In such a case, the presenter makes an operation to turn off the projection data dynamic switch mode in advance, thereby preventing the request such as the question from being shown on the data projected on the screen 7 soon after the request is sent by at least one of the audiences A, B and C during the presentation. So, the presenter is allowed to concentrate on what he or she is presenting.

As the operation mode is switched to a question and answer mode from a presentation mode during the presentation, the projection data dynamic switch mode of the present preferred embodiment is automatically turned on. In this case, the request such as the question from each audience A, B and C is shown on the data projected on the screen 7 after the projection data dynamic switch mode is automatically turned on even when the projection data dynamic switch mode is set off in advance by the presenter. The presenter is allowed to change the setting of the projection data dynamic switch mode during the presentation. Sometimes, it is difficult to continue the presentation with the request such as the question from each audience A, B and C being reflected to the presentation data projected on the screen 7. The presenter may change the setting to turn off the projection data dynamic switch mode then, thereby switching by manual to make the data based on the presentation data 61, the original data, to be projected.

The presentation registration part 31 receives the operation to set a condition of switching to the question and answer mode performed by the presenter, and stores information relating to the setting in the presenter box 52 as question and answer mode switching condition information 68. In the present preferred embodiment, two modes, the presentation mode and the question and answer mode are configured as the operation mode in respect to the proceeding of the presentation. The presentation mode allows the presentation data to be projected on the screen 7 and the presenter to perform his or her presentation. The question and answer mode to which the operation mode is switched automatically as the request from each audience A, B and C meets the predetermined condition in the presentation mode allows the audience request list 64 to be projected on the screen 7. So, the presenter is notified a state of the request such as the question from each audience A, B and C. The operation mode switched to the question and answer mode from the presentation mode let the presenter to see the state of the request such as the question from each audience A, B and C, while at the same time allowing each audience A, B and C to better understand the request such as the question given from other audiences. At least one condition to switch the operation mode to the question and answer mode from the presentation mode as explained above is defined in the question and answer mode switching condition information 68. The question and answer mode switching condition information 68 is described in detail later.

The presentation registration part 31 stores authority information 69 corresponding to each audience A, B and C registered by the presenter is stored in each of the audience A-box 54, the audience B-box 55 and the audience C-box 56. The level of the authority has two stages, “high” and “low,” and either of them is defined in the authority information 69 according to the positions of each audience A, B and C, for example. If “high” is defined in the information, the audience has the authority to access confidential information. Whereas “low” is defined, the audience does not have the authority to access the confidential information.

The presentation execution part 32 becomes operative based on an instruction on execution of the presentation of the presenter to control proceeding of the presentation if the presentation is registered with the information device 10. As shown in FIG. 2, the presentation execution part 32 mainly includes an input process part 41, an answer generation part 42, an answer reflection part 44, a data projection part 45 and a data distribution part 46.

As receiving the various types of information through the network interface 25 during the presentation, the input process part 41 determines the received information and outputs to one of the answer generation part 42, the answer reflection part 44, the data projection part 45 and the data distribution part 46. Each of the answer generation part 42, the answer reflection part 44, the data projection part 45 and the data distribution part 46 executes corresponding process based on the information received from the input process part 41.

The answer generation part 42 receives the request such as the one for answer to question or comment on the presentation entered by the audience from the respective information processing terminals 4a, 4b and 4c of the audiences A, B and C, and executes a process corresponding to the request. When the request received from the audience is the question, the answer generation part 42 automatically obtains an answer to the question and generates answer information. The answer generation part 42 includes a search execution part 43. When the request received from the audience is the question, the search execution part 43 extracts a search keyword from the request on question and conducts a variety of search based on the search keyword, thereby automatically obtaining the answer to the question.

There are four types of searches executed by the search execution part 43. According to the first type of search (hereafter, first search), the search execution part 43 runs a keyword search by the search keyword based on the answer to question information 65 registered in advance by the presenter and automatically obtains the answer from the answer to question information 65. With preparation of at least one anticipated question and planned answer and creation of the answer to question information 65 in advance, the first search allows the answer matching the presenter's idea to be obtained.

According to the second type of search (hereafter, second search), the search execution part 43 extracts a keyword used for conducting effective search from the search filter 66 registered in advance by the presenter and generates a search command combining the extracted keyword and the search keyword with the AND condition. The search execution part 43 then outputs the search command to the search device 11, thereby automatically obtaining the answer matching the search command. With registration of at least one search keyword suitable on the content of the presentation in the search filter 66 by the presenter, the second search allows to narrow down the search to obtain the answer suitable on the content of the presentation even when more than one answer matching the search keyword is registered in the database 12, for example.

According to the third type of search (hereafter, third search), the search execution part 43 runs the keyword search by the search keyword based on at least one previous search result stored in the search history information 29 in the storage device 24 and automatically obtains the answer. The third search allows the answer to be obtained from the previous search result, so the search may be conducted efficiently.

According to the forth type of search (hereafter, forth search), the search execution part 43 generates the search command only with the search keyword extracted from the request on question from the audience and outputs the search command to the search device 11, thereby automatically obtaining the answer matching the search command. When more than one answer matching the search keyword is registered in the database 12, all of the more than one answer is obtained. So, the forth search does not allow to narrow down the search like the second search.

The search execution part 43 is configured to execute one of the first search or the second search of the above-described first to forth searches in preference. The search execution part 43 executes the third search unless the usable answer is obtained through the first or second search. The forth search is executed only when no usable answer is obtained through the third search. That is because, it is possible for the search execution part 43 to obtain many answers to the question (the search keyword) through the forth search, and it may take a long time for the audience to look for the answer suitable on the content of the presentation after the search. Compared with the forth search, the first to third searches allow the smaller number of answers to be obtained. So, the audience is not necessary to invest an effort to find the right answer as much as he or she does for the forth search. In the present preferred embodiment, the forth search has the lowest priority. Also, the third search is the search run based on the previous search result. The answer suitable on the content of the presentation is not always obtained through the third search. So, the third search has its priority lower than the first and second searches'. The user may choose which one of the first and second searches to be executed in preference. According to the present preferred embodiment, the first search has the highest priority, and the second search is executed if the usable search result is not obtained through the first search.

The answer generation part 42 generates answer information based on the answer when the answer to the question is obtained as a result of the search executed by the search execution part 43. In some cases, no answer to the question may be obtained through any of the above-stated searches. In such a case, the answer generation part 42 generates answer information showing “search failed” as the search result, and outputs the answer information to the answer reflection part 44.

The answer reflection part 44 receives the request such as one for answer to question or comment on the presentation entered with the respective information processing terminals 4a, 4b and 4c of the audiences A, B and C and reflects the received request to each information. The answer reflection part 44 also receives the answer information generated by the answer generation part 42 and reflects the answer information to the corresponding information. The answer reflection part 44 registers the request in the audience request list 64 in response to the receipt of the request such as the question or comment on the presentation given by the audience.

As receiving the request on question given by the audience, the answer reflection part 44 adds the answer information received from the answer generation part 42 in the presentation data 63 of the audience who has sent the request and reflects the answer information to the presentation data 63. The answer reflection part 44 registers the answer information in the audience request list 64, while at the same time adding the answer information in the presentation data 62, the shared data. The answer information may be reflected to the presentation data 62.

The answer reflection part 44 executes the different processes to reflect the answer information obtained from the answer generation part 42 to the audience request list 64 or the presentation data 62 or 63 depending on whether or not the answer information contains the confidential information. So, the answer reflection part 44 determines whether or not the answer information obtained from the answer generation part 42 contains the confidential information at first.

When the answer information contains the confidential information, the answer reflection part 44 does not reflect the answer information to the presentation data 62 and the audience request list 64 those may be projected on the screen 7 by the projector 5. It is determined whether or not to reflect the answer information containing the confidential information to the presentation data 63 that is data for the corresponding audience based on the authority information 69 of the audience. By way of example, as “high” is defined in the authority information 69, he or she is authorized to access the confidential information. In this case, the answer reflection part 44 reflects the answer information containing the confidential information to the presentation data 63 of the audience. On the other hand, as “low” is defined in the authority information 69 of the audience, he or she is not authorized to access the confidential information. In this case, the answer reflection part 44 does not reflect any answer information containing the confidential information to the presentation data 63 of the audience. The answer reflection part 44 reflects the answer information to neither of the audience request list 64 nor the presentation data 62 or 63 then.

When the answer information does not contain the confidential information, the answer reflection part 44 reflects the answer information to the presentation data 62 and the audience request list 64 those may be projected on the screen 7 by the projector 5. The answer reflection part 44 reflects the answer information also to the presentation data 63 that is data for the corresponding audience who has sent the request.

The answer reflection part 44 identifies an area that the question is asked about (hereafter, request area) in the presentation data based on the search keyword contained in the request on question and lays the answer information out around the identified area in reflection of the answer information to the presentation data 62 and 63.

The data projection part 45 reads data to be projected on the screen 7 and outputs to the projector 5. When the presentation mode is enabled, the data projection part 45 reads the data of at least one page to be projected from the presentation data 61, the original data, or the presentation data 62, the shared data, and causes the projector 5 to project the read data on the screen 7 by outputting to the projector 5. When, for example, the projection data dynamic switch mode is on, the data projection part 45 reads the data of at least one page to be projected from the presentation data 62, the shared data, and outputs the read data to the projector 5. When the projection data dynamic switch mode is off, the data projection part 45 reads the data of at least one page to be projected from the presentation data 61, the original data, and outputs the read data to the projector 5. When the question and answer mode is enabled, the data projection part 45 reads the audience request list 64 and causes the projector 5 to project the read audience request list 64 on the screen 7 by outputting to the projector 5.

The data distribution part 46 reads the presentation data 63 dedicated to each audience and distributes it to the respective information processing terminals 4a, 4b and 4c of the audiences A, B and C. In distribution to the audience A, the data distribution part 46 reads the presentation data 63 in the audience A-box 54 and transmits it to the information processing terminal 4a. The same process is executed in distribution to each audience B and C.

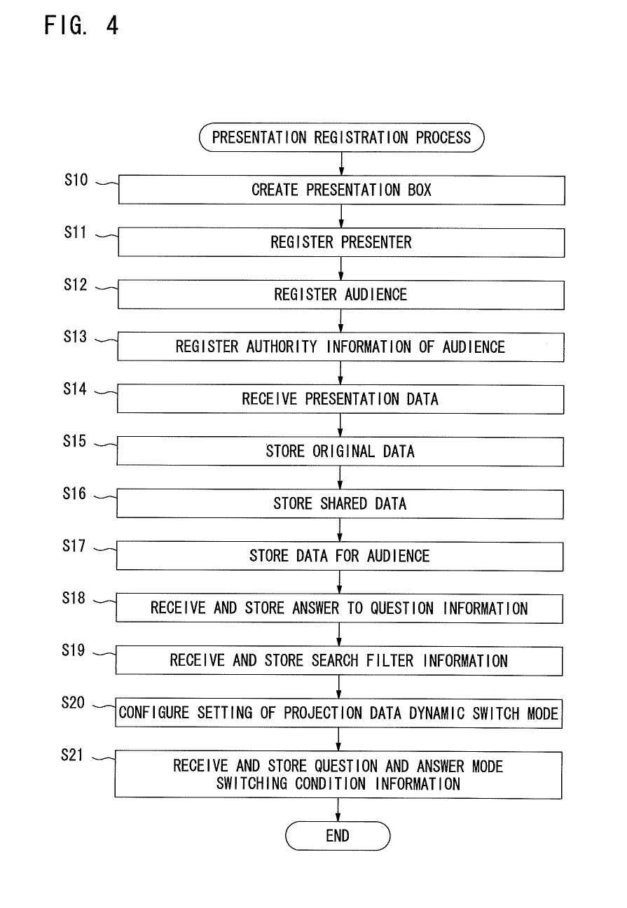

The detail of the operation executed by the controller 20 of the information device 10 is described next. FIG. 4 is a flow diagram explaining an exemplary process sequence on a presentation registration process executed by the controller 20 of the information device 10. An operation to register the presentation performed by the presenter is detected, and the presentation registration part 31 of the controller 20 becomes operative to function. The process is then executed. After starting the process, the presentation registration part 31 creates the presentation box 28 in the storage device 24 (step S10). The presentation box 28 thereby created includes the shared box 51, the presenter box 52 and the audience box 53 created together. The presentation registration part 31 registers information relating to the presenter based on the information entered by the presenter (step S11). The information relating to the presenter not shown in FIG. 3 is stored in the storage region such as the presenter box 52. The presentation registration part 31 registers information relating to each audience A, B and C based on information entered by the presenter (step S12). In response to the registration, the audience A-box 54, the audience B-box 55 and the audience C-box 56 are created as boxes each of them corresponds to each audience A, B and C in the audience box 53. The presentation registration part 31 registers, based on the information as to the authority of each audience A, B and C entered by the presenter, corresponding authority information 63 in the audience A-box 54, the audience B-box 55 and the audience C-box 56, respectively (step S13).

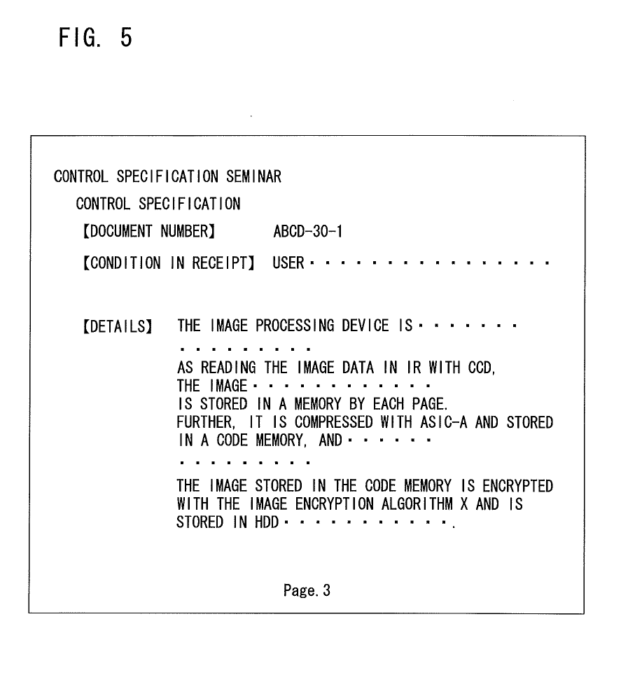

The presentation registration part 31 then receives the entry of the presentation data created in advance by the presenter (step S14). FIG. 5 shows an example of the presentation data. Most presentation data of this kind includes data of a plurality of pages. FIG. 5 shows a part (only the third page) of whole data. The presenter, for example, creates the data of the plurality of pages of the data of FIG. 5 and transmits the created data to the information device 10 with the information processing terminal 3, thereby registering the presentation data.

The presentation registration part 31 stores the original data of the received presentation data in the shared box 51 (step S15). Attribute information that sets the limitation on rewrite of the data is added in the original data. The presentation registration part 31 generates the shared data by copying the original data and stores the generated shared data in the shared box 51 (step S16). Attribute information that allows rewrite of the data is added in the shared data. The presentation registration part 31 also generates the data for the audience by copying the original data and stores the generated data for the audience in the audience A-box 54, the audience B-box 55 and the audience C-box 56, respectively (step S17). The attribute information that allows rewrite of the data is also added in the data for the audience.

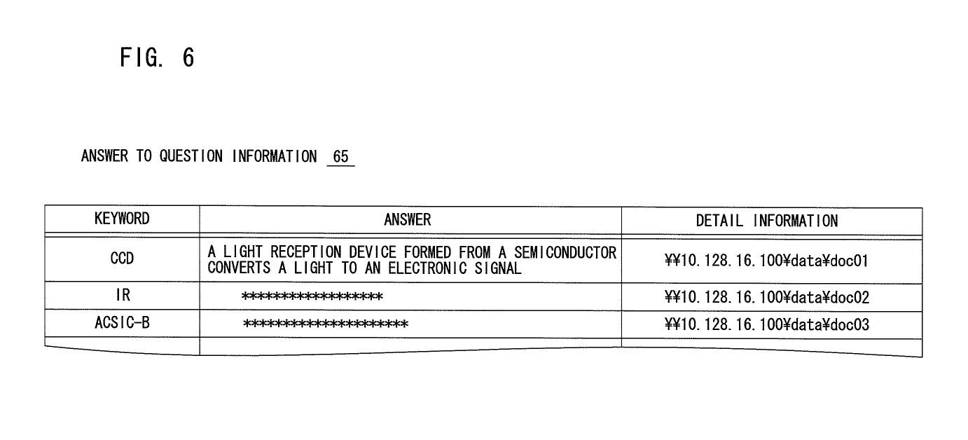

The presentation registration part 31 receives the answer to question information 65 created in advance by the presenter from the information processing terminal 3 and stores in the presenter box 52 (step S18). FIG. 6 shows an example of the answer to question information 65. As shown in FIG. 6, items such as the keyword, the answer and detailed information are registered in the answer to question information 65. At least one term to be prepared in advance the question may be asked by the audience during the presentation is registered as the keyword. So, the term that, for example, the presenter assumes one or more audience is not able to understand of terms appeared in the presentation data is registered as the keyword. At least one sentence explaining the term registered as the keyword is registered for the answer. The keyword and the answer are registered one to one in the answer to question information 65. Link information to access information such as another document which explains the term registered as the keyword more in detail is registered for the detailed information. The detailed information may be registered for each keyword in the answer to question information 65, but is not necessary.

The answer to question information 65 created in advance by the presenter is referred to by the search execution part 43 in execution of the above-explained first search. It is assumed that the audience sends the request on question during the presentation. If the keyword matching the search keyword extracted from the request is registered in the answer to question information 65, the explanation prepared by the presenter may be obtained as the answer to the request. The answer obtained by referring to the answer to question information 65 is suitable on the content of the presentation by the presenter.

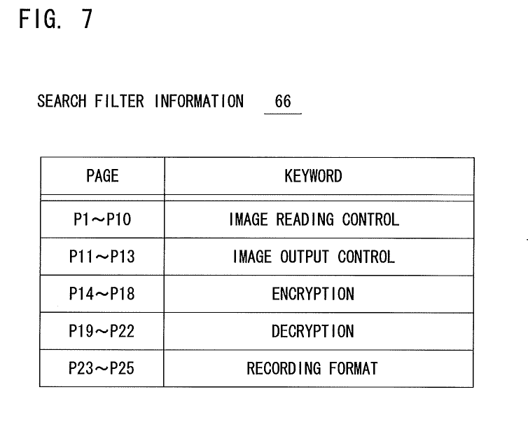

The presentation registration part 31 receives the search filter information 66 created in advance by the presenter from the information processing terminal 3 and stores in the presenter box 52 (step S19). FIG. 7 shows an example of the search filter information 66. As shown in FIG. 7, for example, a page number of the presentation data and the keyword are associated with each other and registered in the search filter information 66. To be more specific, the keyword as to the content is set for every data corresponding to each page included in the presentation data in the search filter information 66. The search filter information 66 is created in advance by the presenter and is referred to by the search execution part 43 in execution of the above-explained second search. The keyword set for the page in which the request area is included is then extracted. The extracted keyword and the search keyword extracted from the request from the audience are combined with the AND condition. The keyword search is run in the database 12 by the keyword in which the AND condition is added by the search device 11. Only the answer that relates to the content of the presentation is extracted as the search result.

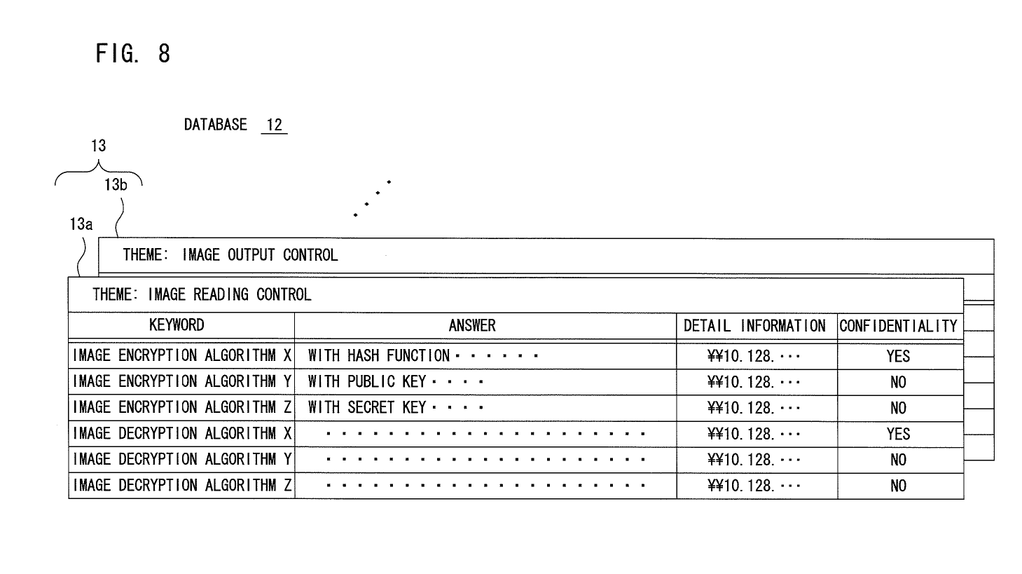

An example of the data configuration of the database 12 is described next. FIG. 8 shows an example of the data configuration of the database 12. The database 12 of FIG. 8 has a structure of groups 13 including a plurality of theme groups 13a and 13b are configured. Each theme group 13a and 13b contains information as to a certain theme of information such as the technical in-house information and other types of information. The theme group 13a includes the information as to the theme “image reading control,” for example. The theme group 13b includes the information as to the theme “image output control.” Each theme group 13a and 13b is table information, for example, in which more than one combination of the keyword, the answer corresponding to the keyword, detailed information showing a destination linked to detailed information as to the keyword and a confidentiality of the answer and the detailed information are registered. The search device 11 searches the database 12 by the search keyword. If the keyword matches the search keyword registered in any of the theme group 13a or 13b, the answer set for the keyword may be obtained.

In some cases, the same keyword is registered in both of the plurality of theme groups 13a and 13b. In this case, more than one answer may be extracted as the result of the search keyword search, and each of the extracted more than one answer may have different content depending on the corresponding theme. By running the search by the search command combining the keyword extracted from the search filter information 66 and the search keyword with the AND condition as described above, the search narrowed down to the suitable theme may be realized. This kind of search is realized even when the same keyword is registered in both of the plurality of theme groups 13a and 13b. Therefore, only the answer that relates to the content of the presentation may be extracted as the search result. The data configuration of the database 12 of FIG. 8 is only one of examples. The data configuration of the database 12 is not limited to one explained above.

The presentation registration part 31 configures an initial setting of the projection data dynamic switch mode based on the operation performed by the presenter (step S20). The projection data dynamic switch mode is set on or off in the present preferred embodiment.

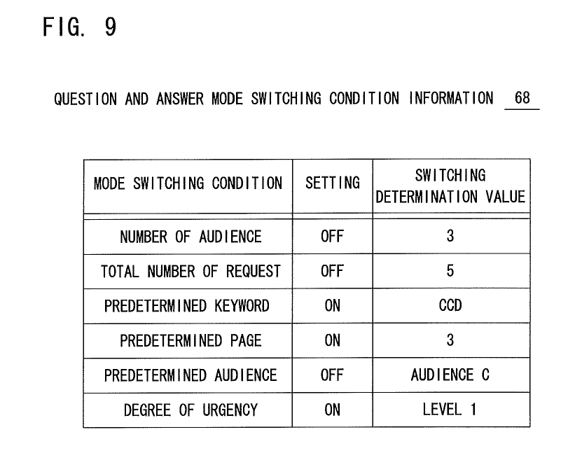

The presentation registration part 31 receives the operation to configure setting relating to the condition to switch the operation mode to the question and answer mode performed by the presenter and stores the question and answer mode switching condition information 68 in the presenter box 52 (step S21). FIG. 9 shows an example of the question and answer mode switching condition information 68. Referring to FIG. 9, the question and answer mode switching condition information 68 is information in which a mode switching condition, a setting and a switching determination value are associated with each other. The conditions as to the number of audience, the total number of request, a predetermined keyword, a predetermined page, a predetermined audience and degree of urgency are set as the mode switching condition.

As the number of the audience who sent the request during the presentation reaches a predetermined number, the operation mode is automatically switched to the question and answer mode from the presentation mode. The condition for such automatic switching of the operation mode is set as the condition as to the number of audience. It is assumed that the setting of the condition is on. In this case, the mode is automatically switched when the number of the audience reaches the value registered for the switching determination value (in FIG. 9, “3”). When the setting of the condition is off, the mode is not automatically switched due to the number of the audience who sent the request.

As the number of the request sent by the audiences A, B and C during the presentation reaches a predetermined number, the operation mode is automatically switched to the question and answer mode from the presentation mode. The condition for such automatic switching of the operation mode is set as the condition as to the total number of request. It is assumed that the setting of the condition is on. In this case, the mode is automatically switched when the total number of request sent by the audiences A, B and C during the presentation reaches the value registered for the switching determination value (in FIG. 9, “5”). When the setting of the condition is off, the mode is not automatically switched due to the total number of the request.

As the predetermined keyword is contained in the request sent by the audiences A, B and C during the presentation, the operation mode is automatically switched to the question and answer mode from the presentation mode at time of the receipt of the request. The condition for such automatic switching of the operation mode is set as the condition as to the predetermined keyword. It is assumed that the setting of the condition is on. In this case, the mode is automatically switched when the request containing the keyword registered for the switching determination value (in FIG. 9, “CCD”) is received from the audiences A, B and C during the presentation. When the setting of the condition is off, the mode is not automatically switched due to the predetermined keyword.

As the request on the predetermined page of the presentation data is sent by the audiences A, B and C during the presentation, the operation mode is automatically switched to the question and answer mode from the presentation mode. The condition for such automatic switching of the operation mode is set as the condition as to the predetermined page. It is assumed that the setting of the condition is on. In this case, the mode is automatically switched when the request on the page registered for the switching determination value (in FIG. 9, “3”) is received from the audiences A, B and C during the presentation. When the setting corresponding to the condition is configured off, the mode is not automatically switched due to the predetermined page.

As the request is sent by the predetermined audience of the audiences A, B and C during the presentation, the operation mode is automatically switched to the question and answer mode from the presentation mode. The condition for such automatic switching of the operation mode is set as the condition as to the predetermined audience. It is assumed that the setting of the condition is on. In this case, the mode is automatically switched when the request given by the predetermined audience registered for the switching determination value (in FIG. 9, “audience C”) of the audiences A, B and C is received during the presentation. When the setting of the condition is off, the mode is not automatically switched due to the predetermined audience.

As the request specifying a predetermined level of urgency is sent by the audiences A, B and C during the presentation, the operation mode is automatically switched to the question and answer mode from the presentation mode. The condition for such automatic switching of the operation mode is set as the condition as to the degree of urgency. It is assumed that the setting of the condition is on. In this case, the mode is automatically switched when the request specifying the level of the urgency registered for the switching determination value (in FIG. 9, “level 1”) is received from the audiences A, B and C during the presentation. When the setting of the condition is off, the mode is not automatically switched due to the degree of urgency.

Each of the conditions in the question and answer mode switching condition information 68 as explained above is set on or off by the presenter. When the condition is set on, a desired value is also set for the switching determination value. Thus, the presentation registration process is completed.

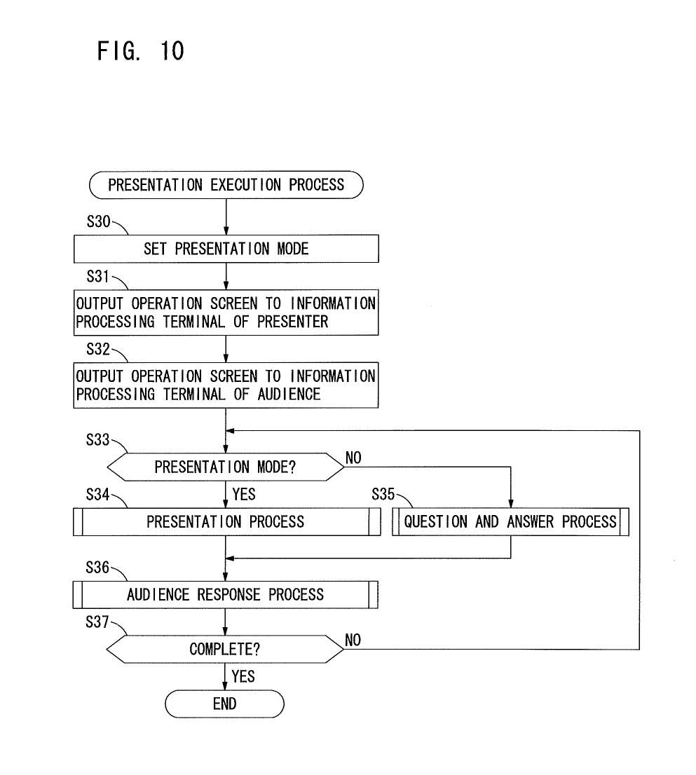

A presentation execution process is described next. FIG. 10 is a flow diagram explaining an exemplary process sequence on the presentation execution process executed by the controller 20 of the information device 10. The instruction on execution of the presentation of the presenter is detected, and the presentation execution part 32 of the controller 20 becomes operative to function. The process is then executed. After starting the process, the presentation execution part 32 sets the operation mode to the presentation mode as a default (step S30).

The presentation execution part 32 outputs an operation screen for the presenter to perform an presentation proceeding operation with the information processing terminal 3 of the presenter (step S31).

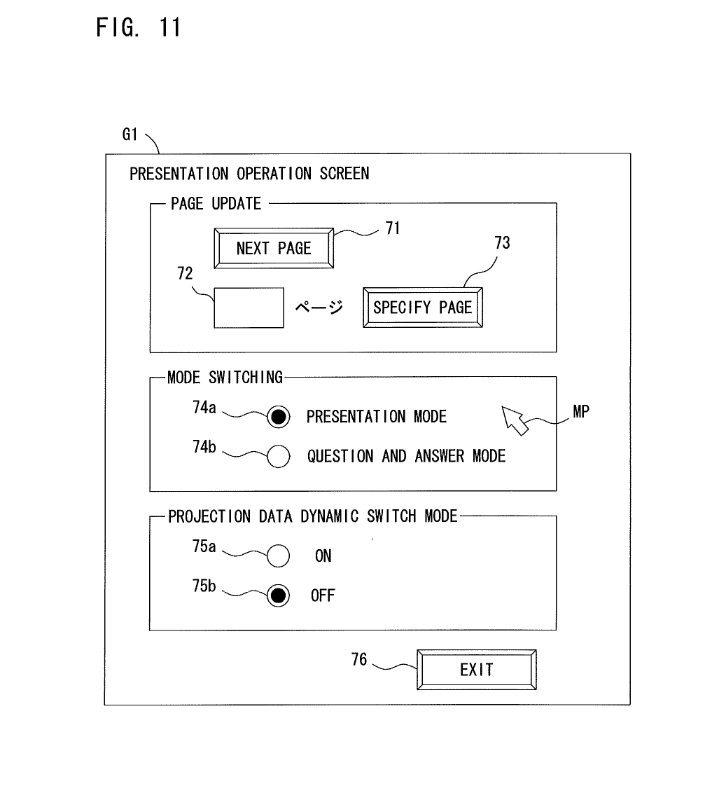

FIG. 11 shows an example of a presentation operation screen G1 displayed on a screen of the information processing terminal 3 of the presenter. Referring to FIG. 11, a page update field for updating the page of the presentation data projected on the screen 7 by the projector 5, a mode switching field for switching the operation mode to one of the presentation mode or the question and answer mode by manual, a projection data dynamic switch mode field for switching to set on and off of the projection data dynamic switch mode and a exit button 76 for ending the presentation are displayed on the operation screen G1.

The page update field includes a next page button 71 for updating the page of the projected data to a next page, a entry field 72 for entering the page number to make the desired page displayed and a specified page button 73 for making the data of the page corresponding to the page number entered in the entry field 72 to be projected. The presenter clicks the next page button 71, or enters the desired page number in the entry field 72 and clicks the specified page button 73 with a pointer MP displayed on the operation screen G1 by operating the information processing terminal 3. So, the presenter is allowed to make the desired page projected on the screen 7.

The mode switching field includes two buttons 74a and 74b for making a choice between the presentation mode or the question and answer mode. The presenter selects either of the button 74a or 74b with the pointer MP displayed on the operation screen G1 by operating the information processing terminal 3. So, the presenter is allowed to set the desired operation mode.

The projection data dynamic switch mode field includes two buttons 75a and 75b for making a choice between on or off. The presenter selects either of the button 75a or 75b with the pointer MP displayed on the operation screen G1 by operating the information processing terminal 3. So, the presenter is allowed to switch the projection data dynamic switch mode on and off.

The presentation execution part 32 outputs an operation screen for each audience A, B and C to perform a variety of operations with the presentation proceeding to the respective information processing terminals 4a, 4b and 4c of the audiences A, B and C (step S32).

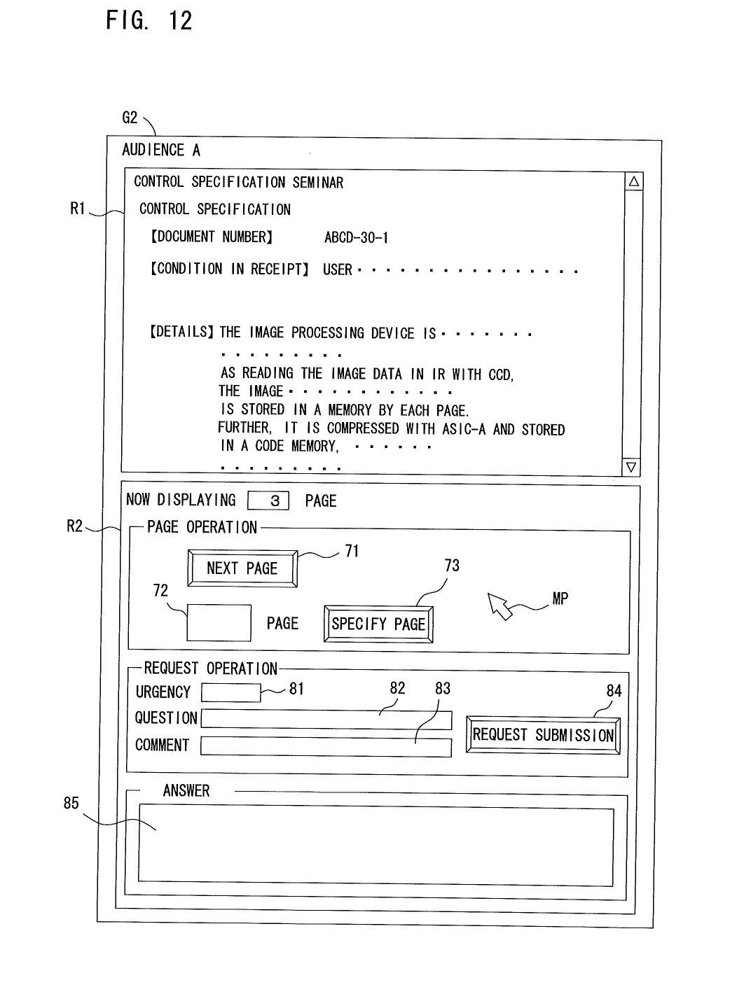

FIG. 12 shows an example of an operation screen G2 displayed on a screen of the information processing terminal 4a of the audience A. The operation screen G2 of FIG. 12 is for the audience A, while the same operation screen is displayed on a screen of the respective information processing terminals 4b and 4c of the other audiences B and C. Referring to FIG. 12, a data display region R1 for displaying the presentation data 63 distributed from the information device 10 and an operation region R2 with which the audience A enters the variety of operations are displayed on the operation screen G2. More specifically, for example, the data of one page distributed from the information device 10 is displayed in the data display region R1. The operation region R2 includes the page number of the data displayed in the data display region R1. In addition to the page number, the operation region R2 includes a page operation field for specifying the page to be displayed in the data display region R1, a request operation field for entering and sending the request such as the question or comment on the presentation and an answer field for displaying the answer when the answer to the question is obtained.

The page operation field of the operation screen G2 includes the next page button 71, the page number entry field 72 and the specified page button 73 as well as the operation screen G1 (see FIG. 11). The audience A clicks the next page button 71, or enters the desired page number in the entry field 72 and clicks the specified page button 73 with the pointer MP displayed on the operation screen G2 by operating the information processing terminal 4a, thereby updating the presentation data 63 displayed in the data display region R1 to the desired page.

The request operation field includes an urgency entry field 81 for entering the degree of urgency of the request, a question entry field 82 for entering the question and a comment entry field 83 for entering the comment and a request submission button 84 for sending the information entered in the entry fields 81 to 83 as the request from the audience A. The audience A enters the question in the question entry field 82 when he or she has the question on the content of the presentation. The audience A enters the comment in comment entry field 83 to send the comment. The audience A also enters, for example, one of the level 1 or 2 in the urgency entry field 81 to specify the urgency of the question or the comment. The request such as the question or comment is sent to the information device 10 by clicking the request submission button 84. When the answer to the question is received from the information device 10 after sending the request on question to the information device 10, the answer is displayed in an answer field 85.

Referring back to FIG. 10, the presentation execution part 32 executes a loop process in steps 33 to S37 to start the presentation proceeding next. As starting the loop process, the presentation execution part 32 determines whether or not the present operation mode is the presentation mode (step S33).

As the operation mode is the presentation mode (when a result of step S33 is YES), the presentation execution part 32 executes a presentation process (step S34). In the presentation process, one of the presentation data 61, the original data, or the presentation data 62, the shared data, is selected as the presentation data to be projected on the screen 7. The data of at least one page to be projected is read and output to the projector 5. The question and answer mode switching condition information 68 is also read, and the operation mode is switched to the question and answer mode from the presentation mode depending on the present state of the request given from each audience A, B and C. The presentation process is described in detail later.

As the operation mode is the question and answer mode (when a result of step S33 is NO), the presentation execution part 32 executes a question and answer process (step S35). In the question and answer process, the audience request list 64 is read and output to the projector 5. In response to the operation performed by the presenter to switch the operation mode to the presentation mode from the question and answer mode, a process to switch the operation mode to the presentation mode from the question and answer mode is executed, while at the same time the projection data dynamic switch mode is turned on. The question and answer process is described in detail later.

The presentation execution part 32 executes an audience response process (step S36). In the audience response process, each presentation data 63 to be distributed to the respective information processing devices 4a, 4b and 4c of the audiences A, B and C is read and output to the corresponding information processing devices 4a, 4b and 4c. The process corresponding to the request is also executed in the audience response process when the request such as the question or comment is sent from each audience A, B and C. The audience response process is described in detail later.

The presentation execution part 32 determines whether or not to complete the presentation (step S37). More specifically, the presentation execution part 32 determines whether or not the exit button 76 (see FIG. 11) is operated by the presenter. As the presentation is determined not to be completed (when a result of step S37 is NO), the process in steps S33 to S37 as described above is repeatedly executed. As the presentation is determined to be completed (when a result of step S37 is YES), the presentation execution process is completed.

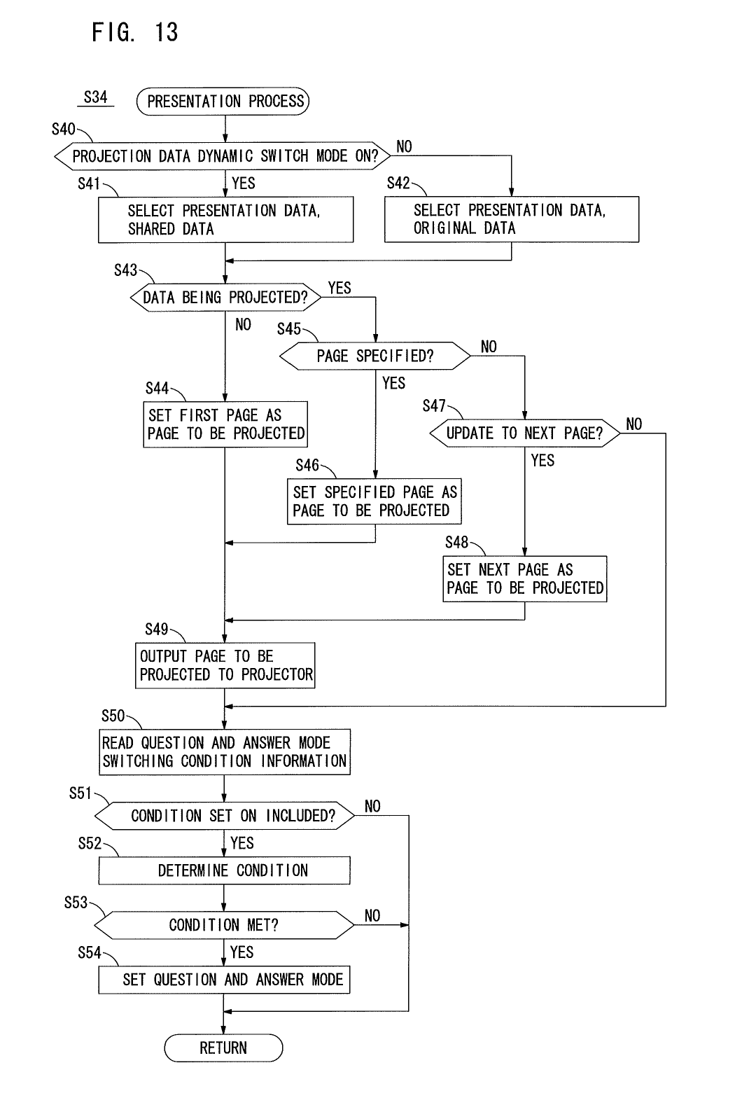

FIG. 13 is a flow diagram explaining in detail an exemplary process sequence of the presentation process (step S34). In response to start of the presentation process, the presentation execution part 32 determines whether or not the projection data dynamic switch mode is on (step S40). If the projection data dynamic switch mode is on (when a result of step S40 is YES), the presentation data 62, the shared data, is selected as the data to be projected (step S41). If the projection data dynamic switch mode is off (when a result of step S40 is NO), the presentation data 61, the original data, is selected as the data to be projected (step S42).

The presentation execution part 32 determines whether or not the presentation data is being projected on the screen 7 at the time of determination (step S43). When the presentation data is not being projected (when a result of step S43 is NO), the first page is set as the page to be projected (step S44). When the presentation data has already been projected (when a result of step S43 is YES), the presentation execution part 32 determines whether or not the operation to enter the page number to specify the page to be projected is received from the presenter (step S45). As the page number is specified by the presenter (when a result of step S45 is YES), the page corresponding to the page number specified by the presenter is set as the page to be projected (step S46). As the page number is not specified by the presenter (when a result of step S45 is NO), the presentation execution part 32 determines whether or not an instruction on update the page to the next is received from the presenter (step S47). In response to the instruction of the presenter (when a result of step S47 is YES), the page corresponding to the following page number is set as the page to be projected (step S48). The presentation execution part 32 then reads the data corresponding to the page set in step S44, S46 or S48 from the presentation data 61 or 62 to be projected and outputs to the projector 5 (step S49). The projector 5 projects the data received from the presentation execution part 32 on the screen 7, and updates the projected page. If no instruction on update the page to the next is received from the presenter (when a result of step S47 is NO), the page currently projected is not necessary to be updated. In such a case, the presentation execution part 32 moves on to the process in step S50.

The presentation execution part 32 reads the question and answer mode switching condition information 68 (step S50), and determines whether or not any mode switching condition set on is included in the question and answer mode switching condition information 68 (step S51). When only mode switching condition set off is included (when a result of step S51 is NO), the presentation process is completed. In this case, the operation mode is not automatically switched to the question and answer mode during the presentation. When any mode switching condition set on is included in the question and answer mode switching condition information 68 (when a result of step S51 is YES), the value registered for the switching determination value corresponding to the mode switching condition is read and the determination on the mode switching condition is executed (step S52). In the determination, comparison between the request such as the question or comment sent by each audience A, B and C stored by then and the switching determination value is made. The presentation execution part 32 determines whether or not the state of the request at the determination meets the mode switching condition (step S53). As the state of the request at the determination does not meet the switching determination value of the mode switching condition (when a result of step S53 is NO), the presentation process is completed. As the state of the request at the determination meets the switching determination value of the mode switching condition (when a result of step S53 is YES), the presentation execution part 32 changes the setting of the operation mode from the presentation mode to the question and answer mode (step S54). Thus, the operation mode is automatically switched to the question and answer mode.

The question and answer mode switching condition information 68 of FIG. 9, for example, shows that the setting corresponding to the predetermined keyword and the predetermined page registered as the mode switching condition is on. So, in response to receipt of the request containing the keyword “CCD” from any of the audiences A, B and C, or in response to receipt of the request such as the question or comment on “third page” of the presentation data from any of the audiences A, B and C, the operation mode is switched to the question and answer mode from the presentation mode.

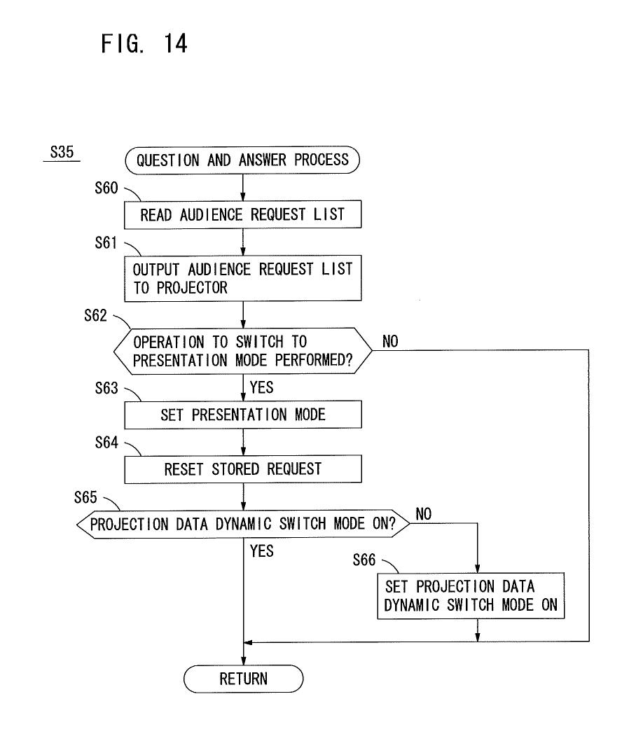

FIG. 14 is a flow diagram explaining in detail an exemplary process sequence of the question and answer process (step S35). In response to start of the question and answer process, the presentation execution part 32 reads the audience request list 64 (step S60).

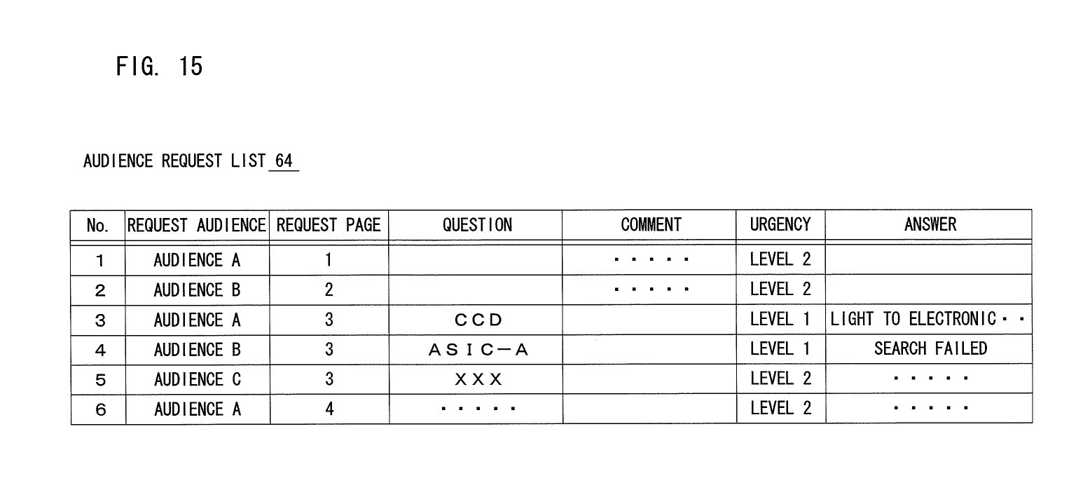

FIG. 15 shows an example of the audience request list 64. The audience request list 64 is information having the request such as the question or comment received from the respective information processing terminals 4a, 4b and 4c of the audiences A, B and C after start of the execution of the presentation listed in order of receipt. The audience request list 64 includes a number field for showing the receipt order, a requested audience field for showing the audience who sent the request, a request about page field for showing the request toward which page of the presentation data 63 is sent, a question field for showing the question, a comment field for showing the comment, an urgency field for showing the degree of urgency specified by the audience and an answer field for storing the answer when the answer to the question is obtained. For the degree of urgency, level 1 shows high urgency and level 2 shows low urgency.

The presentation execution part 32 reads the audience request list 64 in the presentation box 28 and outputs to the projector 5 (step S61). The projector 5 then projects the audience request list 64 as shown in FIG. 15 on the screen 7. By seeing the audience request list 64 projected on the screen 7, the presenter and the audiences A, B and C are able to share the question and the comment sent by each audience A, B and C. If the answer to the question is obtained, the audiences A, B and C are able to share the answer in the answer field projected on the screen 7.

The presentation execution part 32 determines whether or not the operation to switch the operation mode to the presentation mode is performed by the presenter (step S62). When the operation to switch the operation mode to the presentation mode is not performed (when a result of step S62 is NO), the presentation execution part 32 maintains the question and answer mode and completes the question and answer process.

When the operation to switch to the presentation mode is performed by the presenter (when a result of step S62 is YES), the presentation execution part 32 changes the setting of the operation mode to the presentation mode (step S63). The information to manage the stored state of the request that is used in the above-described presentation process in step S52 (see FIG. 13) is reset (step S64). This information is managed separately from the above-mentioned audience request list 64. In response to the reset in step S64, the presentation mode is maintained until the state of the request meets the mode switching condition again.

The presentation execution part 32 determines whether or not the projection data dynamic switch mode is on (step S65). As the projection data dynamic switch mode is on, the question and answer process is completed here. As the projection data dynamic switch mode is off (when a result of step S65 is NO), the projection data dynamic switch mode is turned on (step S66), and the process is completed. With change of the setting to turn on the projection data dynamic switch mode, the presentation mode after the change allows the presentation data 62, the shared data, to be read and projected on the screen 7. After the change, the setting of the projection data dynamic switch mode, however, may be changed to turn off any time the presenter likes by manual by the presenter.

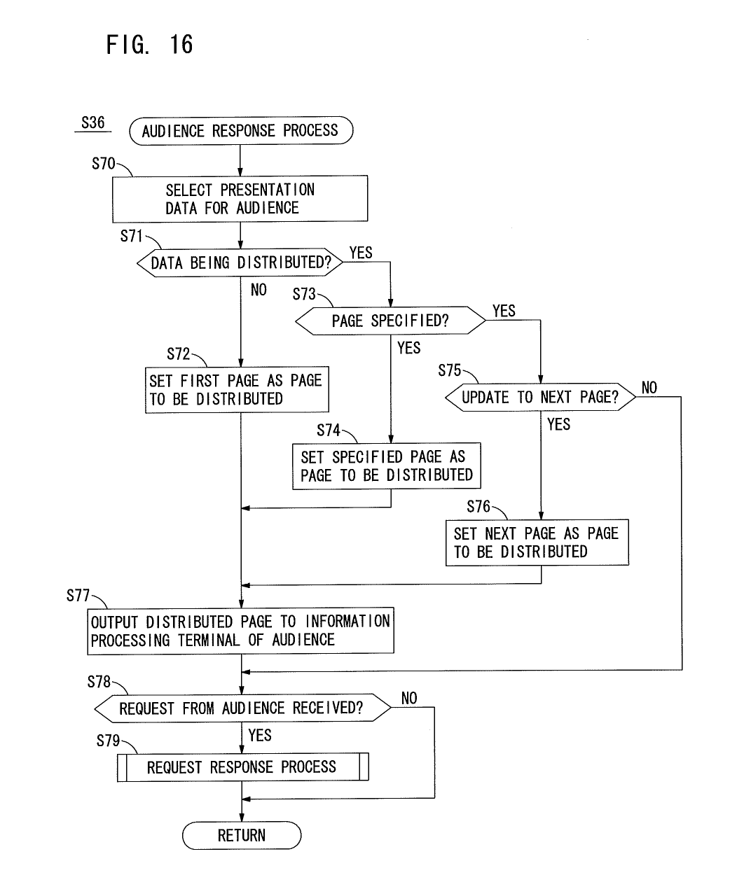

FIG. 16 is a flow diagram explaining in detail an exemplary process sequence of the audience response process (step S36). In response to start of the audience response process, the presentation execution part 32 selects the presentation data 63 for the audience as the data to be projected (step S70).

The presentation execution part 32 determines whether or not the presentation data 63 is being distributed to the respective information processing terminals 4a, 4b and 4c of the audiences A, B and C at time of the determination (step S71). When the presentation data 63 is not being distributed (when a result of step S71 is NO), the first page is set as the page to be distributed (step S72). When the presentation data 63 is being distributed (when a result of step S71 is YES), the presentation execution part 32 determines whether or not the operation to enter the page number to specify the page to be distributed is received from the audience A, B or C (step S73). As the page number is specified by the audience A, B or C (when a result of step S73 is YES), the page corresponding to the page number specified by the audience A, B or C is set as the page to be distributed (step S74). As the page number is not specified by the audience A, B or C (when a result of step S73 is NO), the presentation execution part 32 determines whether or not the instruction on update the page to the next is received from the audience A, B or C (step S75). In response to the instruction of the audience A, B or C (when a result of step S75 is YES), the page corresponding to the following page number is set as the page to be distributed (step S76). The presentation execution part 32 then reads the data corresponding to the page set in step S72, S74 or S76 from the presentation data 63 to be distributed and outputs to the respective information processing terminals 4a, 4b and 4c of the audiences A, B and C (step S77). The image of one page of the presentation data 63 is displayed in the data display region R1 with the respective information processing terminals 4a, 4b and 4c of the audiences A, B and C. If no instruction on update the page to the next is received from the audience A, B or C (when a result of step S75 is NO), the page currently being distributed is not necessary to be updated. In such a case, the presentation execution part 32 moves on to the process in step S78.

The presentation execution part 32 then determines whether or not the request is received from the audience A, B or C (step S78). As no request is received from the audience A, B or C, the audience response process is completed here. As any request is received from the audience A, B or C (when a result of step S78 is YES), a request response process is executed (step S79).

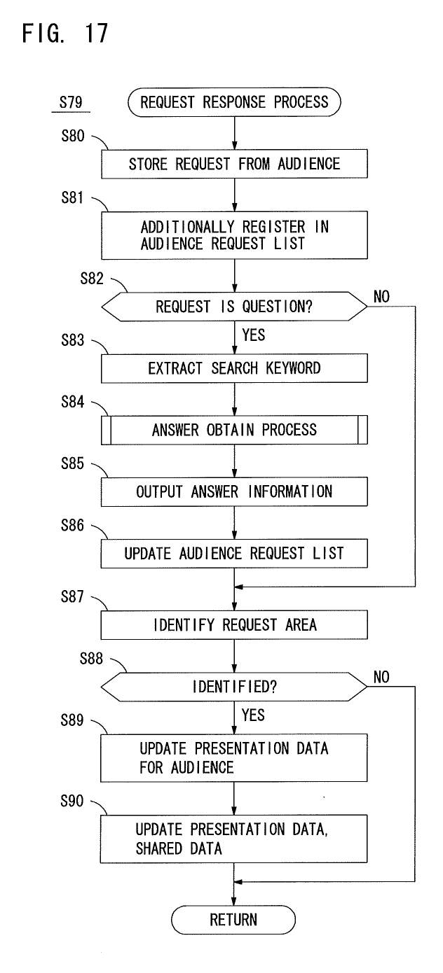

FIG. 17 is a flow diagram explaining in detail an exemplary process sequence of the request response process (step S79). In response to start of the audience response process, the presentation execution part 32 stores the request from each audience A, B and C (step S80). The presentation execution part 32 registers the request from each audience A, B and C in the audience request list 64 (step S81). The presentation execution part 32 specifies the audience and the page the request is asked about (hereafter, request page) based on the request from the audience A, B or C and registers in the audience request list 64. The presentation execution part 32 determines if the request is the question or the comment. As the request is the question, the question is registered in the question field. As the request is the comment, the comment is registered in the comment field. The degree of urgency is determined, and the urgency is registered in the urgency field.

The presentation execution part 32 determines whether or not the request from the audience A, B or C is the request on question (step S82). If the request is the request on question, the question contained in the request is extracted as the search keyword (step S83). The search keyword thereby extracted is the same word as the question registered in the question field of the audience request list 64. After extracting the search keyword, the presentation execution part 32 executes an answer obtain process to automatically obtain the answer corresponding to the search keyword (step S84).

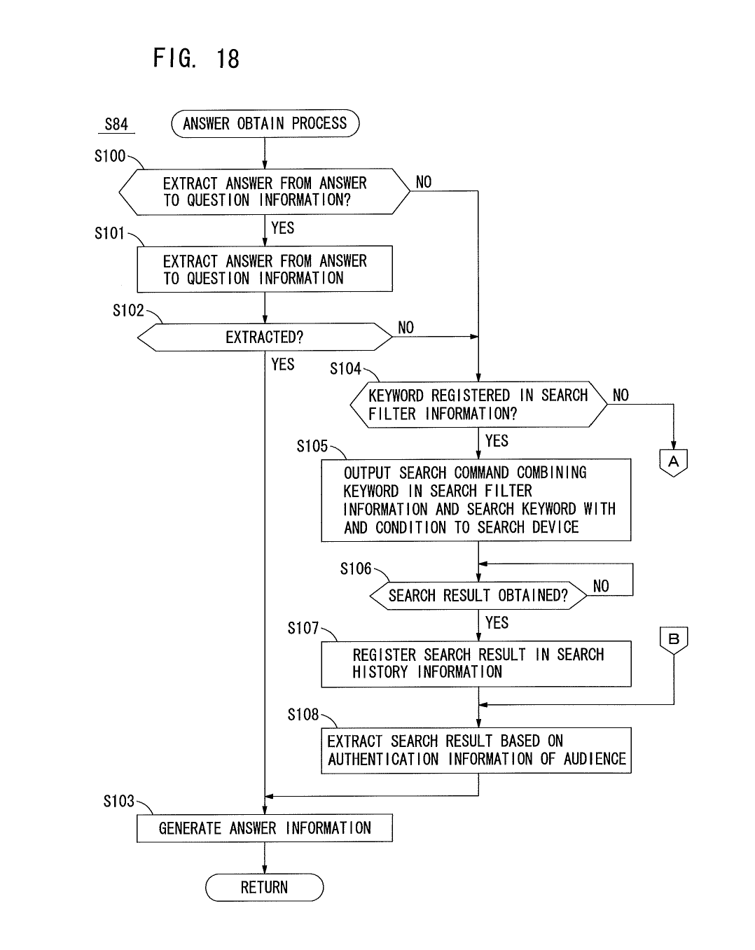

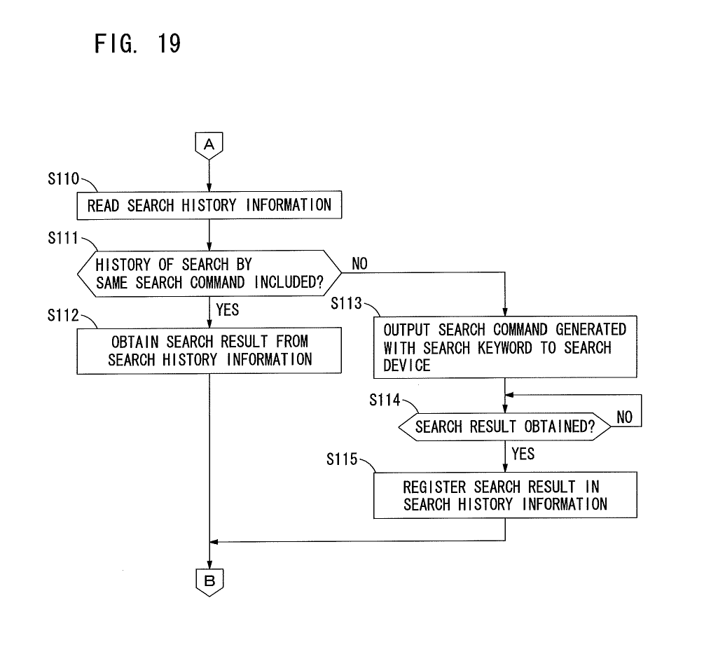

FIGS. 18 and 19 are flow diagrams explaining in detail an exemplary process sequence of the answer obtain process (step S84). In response to start of the audience response process, the presentation execution part 32 determines whether or not to extract the answer corresponding to the search keyword from the answer to question information 65 (step S100). In this determination, the presentation execution part 32 determines whether or not the setting to refer to the answer to question information 65 is disabled in advance by the presenter, for example. When the setting to refer to the answer to question information 65 is continued to be enabled, the result is YES, whereas the setting is disabled, the result is NO. The presentation execution part 32 starts the first search as mentioned above to extract the answer corresponding to the search keyword from the answer to question information 65. To be more specific, the presentation execution part 32 reads the answer to question information 65 of FIG. 6 and checks the search keyword against the keyword registered in the answer to question information 65, thereby determining whether or not any keyword matching the search keyword is registered. As the keyword matching the search keyword is registered, the answer set for the keyword is extracted (step S101). If the detailed information is set for the keyword as well, the detailed information is extracted. The keyword matching the search keyword is not always registered in the answer to question information 65. The answer to the question is not allowed to be extracted from the answer to question information 65 then. So, the presentation execution part 32 determines whether or not the answer is extracted from the answer to question information 65 (step S102). As the answer is extracted (when a result of step S102 is YES), the answer information is generated based on the extracted answer (step S103). As the answer is not extracted (when a result of step S102 is NO), the presentation execution part 32 moves on to step S104 to make a determination for the second search. As the result of the determination in step S100 is NO, the presentation execution part 32 also moves on to step S104 to make the determination for the second search.

In step S104, the presentation execution part 32 reads the search filter information 66 of FIG. 7 and determines whether or not the keyword is registered in the search filter information 66. In the determination, the presentation execution part 32 checks the request page that the request on the question is about and determines whether or not the keyword set for the request page is registered in the search filter information 66.

As the keyword set for the request page is registered in the search filter information 66 (when a result of step S104 is YES), the presentation execution part 32 reads the keyword and generates the search command combining the extracted keyword and the search keyword with the AND condition. The presentation execution part 32 then outputs the generated search command to the search device 11 (step S105). The search device 11 starts the execution of the search process to search the database 12 by the search command to extract the answer. The search command thereby generated is a combination of the extracted keyword and the search keyword with the AND condition. So, the answer corresponding to the search keyword, the detailed information and the information on confidentiality are extracted by narrowing down the theme groups when the database 12 has its data structure as shown in FIG. 8 is searched by the search device 11. The search device 11 outputs the extracted information as the search result to the presentation execution part 32. The search device 11 runs the search by the search command, but the answer corresponding to the search keyword is not always extracted. When the answer is not extracted, the search device 11 outputs the search result showing that the search resulted in failure to the presentation execution part 32.

After transmitting the search command to the search device 11, the presentation execution part 32 is put into a waiting state until obtaining the search result from the search device 11 (step S106). In response to the receipt of the search result, the presentation execution part 32 registers the search result in the search history information 29 (step S107). The search result is associated with the search command and registered in the search history information 29. The presentation execution part 32 extracts the search result based on the authentication information 69 of the audience from the search result obtained from the search device 11 (step S108). By way of example, it assumes that the “low” is defined in the authentication information 69 of the audience who sent the request on question. In this case, the audience does not have the authority to access the confidential information. So, only the answer that does not contain the confidential information is extracted from at least one answer obtained as the search result. Whereas, it assumes that the “high” is defined in the authentication information 69 of the audience who sent the request on question. In this case, the audience has the authority to access confidential information. So, all of at least one answer obtained as the search result is extracted. As the search results in failure, the information showing that the search resulted in failure is extracted. The presentation execution part 32 generates the answer information based on the search result extracted in step S108 (step S103).

As the keyword set for the request page is not registered in the search filter information 66 (when a result of step S104 is NO), the presentation execution part 32 moves on to the process in the flow diagram of FIG. 19 and determines whether or not to execute the third search. More specifically, the presentation execution part 32 reads the search history information 29 (step S110), and determines whether or not the history of previously conducting the search by the search command the same one as this time is included in the search history information 29 (step S111).

When the same search command is registered in the search history information 29 (when a result of step S111 is YES), the presentation execution part 32 extracts the previous search result matches the search command from the search history information 29, thereby obtaining the search result (step S112). By moving on to step S108 of FIG. 18, the presentation execution part 32 extracts the search result based on the authentication information 69 of the audience from the search result obtained from the search history information 29 (step S108). The presentation execution part 32 generates the answer information based on the extracted search result (step S103).

When the same search command is not registered in the search history information 29 (when a result of step S111 of FIG. 19 is NO), the presentation execution part 32 generates the search command with only the search keyword and outputs the search command to the search device 11 (step S113). The search device 11 starts the execution of the search process to search the database 12 by the search command to extract the answer. The search command is generated on the basis of only the search keyword. So, the answer corresponding to the search keyword, the detailed information and the information on confidentiality are extracted from the multiple theme groups by the search device 11 when the database 12 with the data structure as shown in FIG. 8 is searched. The large number of the answer corresponding to the search command may be extracted. The search device 11 outputs the extracted information as the search result to the presentation execution part 32. The answer corresponding to the search keyword is not always extracted. When the answer is not extracted, the search result showing that the search resulted in failure is output to the presentation execution part 32.

After transmitting the search command to the search device 11, the presentation execution part 32 is put into the waiting state until obtaining the search result from the search device 11 (step S114). In response to the receipt of the search result, the presentation execution part 32 registers the search result in the search history information 29 (step S115). The search result is associated with the search command and registered in the search history information 29 also in this case. By moving on to step S108 of FIG. 18, the presentation execution part 32 extracts the search result based on the authentication information 69 of the audience from the search result obtained from the search device 11 (step S108), and generates the answer information based on the extracted search result (step S103). The presentation execution part 32 returns to the process of the flow diagram in FIG. 17.

After the answer obtain process (step S84) as described above, the presentation execution part 32 outputs the answer information generated through the answer obtain process to the respective information processing terminals 4a, 4b and 4c of the audiences A, B and C (step S85). So, the answer information received from the presentation execution part 32 is displayed in the answer field in the operation screen G2 displayed on the screen of each information processing terminal 4a, 4b and 4c. The number of the answer obtained as the result of the first to third search as explained above should be relatively small. Therefore, the number of the displayed answer should also be small. The audiences A, B and C are allowed to easily find the answer. The number of the answer obtained as the result of especially the first and second search is small and the content of the answer is suitable on the presentation. The audiences A, B and C are allowed to easily check the answer suitable on the presentation.

The presentation execution part 32 additionally registers the answer information output to the information processing terminal 4a, 4b or 4c in the answer field in the audience request list 64, thereby updating the audience request list 64 (step S86). When the answer information output to the information processing terminal 4a, 4b or 4c contains the confidential information, the audience request list 64 is not updated. This is to prevent the answer containing the confidential information from being disclosed to the audience who is not authorized to access the confidential information. After the process in step S86, the presentation execution part 32 moves on to the step S87 next. When the result of the determination in step S82 is NO, the presentation execution part 32 also moves on to the step S87.

The presentation execution part 32 identifies the request area in the request page that the request such as the question or the comment is given by the audience A, B or C (step S87). When, for example, the request on question is received, the presentation execution part 32 determines whether or not a character strings matching the search keyword is included in the character strings in the request page. The area of the character strings is identified if the character strings matching the search keyword is included. When, for example, the comment is received, the presentation execution part 32 determines whether or not the character strings matching the character strings included in the comment is included in the character strings in the request page. The area of the character strings is identified if the character strings matching the character strings included in the comment is included in the request page. In some cases, the request area is not allowed to be identified even with this process. So, the presentation execution part 32 determines whether the request area may be identified. If the request area is not specified, the process completes. If the request area is specified (when a result of step S88 is YES), the presentation execution part 32 moves on to step S89 to execute a process to reflect to the presentation data.

After identifying the request area, the presentation execution part 32 reads the presentation data 63 for the audience, and processes the request area in the request page of the presentation data 63 to reflect the request or the answer. The presentation execution part 32 then updates the presentation data 63 (step S89). The request area of the presentation data 63 is decorated, for example, by underlining the area, and the answer information generated as described above is laid out around the request area if the request is the question. The request from the audience and/or the answer automatically obtained is reflected to the presentation data 63. After the reflection, the presentation data 63 displayed in the data display region R1 with the respective information processing terminals 4a, 4b and 4c shows the request and/or the answer additionally recorded.

The presentation execution part 32 reads the presentation data 62, the shared data, and processes the request area in the request page of the presentation data 62 to reflect the request or the answer as required. The presentation execution part 32 then updates the presentation data 62 (step S90). As well as the above process, the request area of the presentation data 62 is decorated, for example, by underlining the area, and the answer information generated as described above is laid out around the request area if the request is the question. In the update process in step S90, the confidential data is excluded from the information to be reflected to the presentation data 62 when the answer information contains the confidential data, which is to prevent the presentation data 62 to be projected on the screen 7 from containing the confidential information. The request from the audience and/or the answer automatically obtained is reflected to the presentation data 62. After the reflection, the presentation data 62 projected on the screen 7 shows the request and/or the answer additionally recorded. The presenter and the audiences A, B and C are allowed to share the information additionally recorded.

Thus, all processes relating to the audience response process (step S36) shown in FIG. 16 are completed. The audience response process (step S36) of FIG. 16 is executed for each of the audience A, B and C.

The presentation execution part 32 registers, with the above-described presentation execution process, the request in the audience request list 64 in response to the receipt of the request such as the question or the comment from each audience A, B and C with the presentation proceeding. When the question is received from the audience A, B or C, the answer to the question is automatically obtained. The obtained answer is displayed on the corresponding information processing terminal 4a, 4b or 4c of the audience who sent the request. In the present preferred embodiment, the first search and the second search are executed in preference to obtain the answer to the question. The first search is for obtaining the answer by referring to the answer to question information 65 created in advance by the presenter, and the second search is for obtaining the answer by searching the database 12 using the AND condition based on the search filter information 66 created in advance by the presenter. The small number of the answer suitable on the content of the presentation may be provided to the audience. The less time and effort consumed to select the answer suitable on the content of the presentation is required for the audience. The audience is allowed to concentrate on the presentation.

As the request such as the question or comment given by each audience A, B and C with the presentation proceeding meets the condition defined in the question and answer mode switching condition information 68, the data projected on the screen 7 is switched to the audience request list 64 when the request meets the condition. Therefore, the presenter is able to know the request such as the question or comment given by each audience A, B and C meets the predetermined condition, and is able to check what kind of question and comment are given by then with the audiences A, B and C. As the operation mode is switched to the presentation mode from the question and answer mode by the presenter after the condition is met, the presentation data 62, the shared data, is selected as the data to be projected on the screen 7. So, the presentation data to which the request such as the one for answer to question or comment given by each audience A, B and C is reflected is projected on the screen 7. The presentation data 62 projected on the screen 7 includes the request area the request is given by the audience A, B or C is decorated, for example, is underlined and the answer information is laid out around the area the request is given if the request is the question. By seeing the presentation data 62 projected on the screen 7, the presenter and each audience A, B and C are able to easily know what item or area is asked or commented by each audience A, B and C. Also, the answer to the question asked by one of the audiences may be shared by other audiences. The presenter is allowed to provide the supplementary explanation as required at the right timing, which helps increasing the depth of understanding of each audience in the presentation.

The operation screen G2 displayed on the screen of the respective information processing terminals 4a, 4b and 4c of the audiences A, B and C when each audience A, B and C sent the request on question during the presentation is explained next.

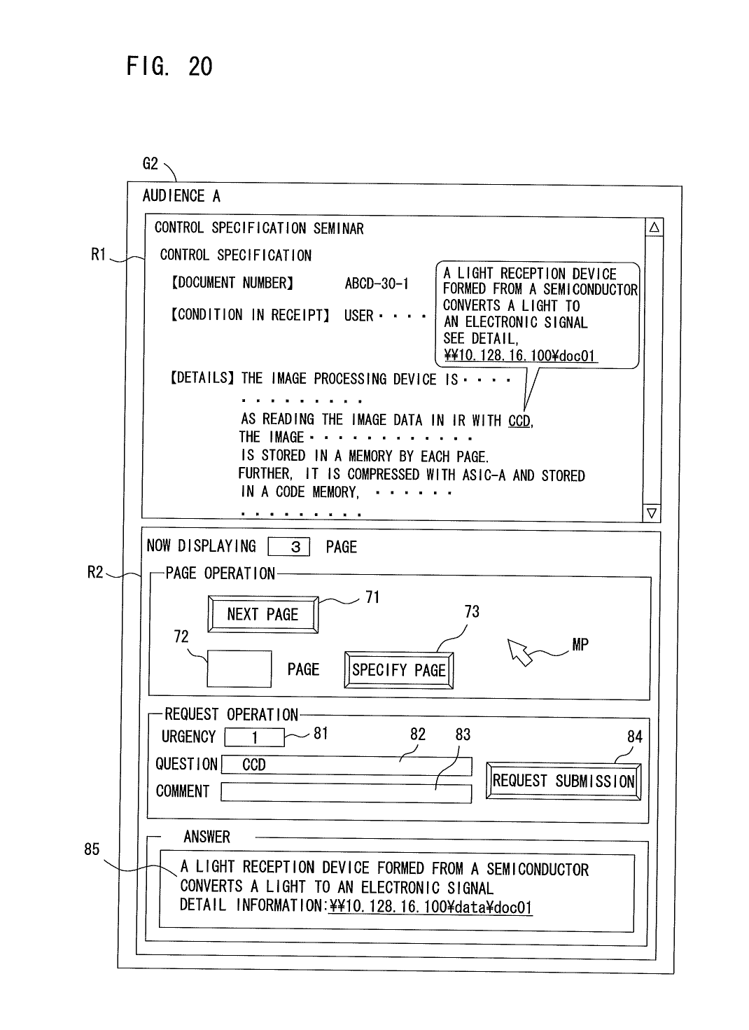

FIG. 20 shows an example of the operation screen G2 displayed on the information processing terminal 4a of the audience A. The presentation data of FIG. 5 is displayed in the data display region R1 of the operation screen G2 of FIG. 20. It is assumed that the “CCD” is entered in the question entry field 82 of the request operation field and the request submission button 84 is clicked after specifying “level 1” in the urgency entry field 81 by the audience A to look up the meaning of the term “CCD” while the data is displayed. In this case, the presentation execution part 32 obtains the answer corresponding to the “CCD” from the answer to question information 65 shown in FIG. 6 and outputs the answer information to the information processing terminal 4a. Thus, the answer extracted from the answer to question information 65 is displayed in the answer field 85 as shown in FIG. 20. On the presentation data 63 displayed in the data display region R1, the character strings “CCD” identified as the request area is underlined, and the answer information is shown around the character strings. The audience A is allowed to understand the meaning of the term “CCD.”

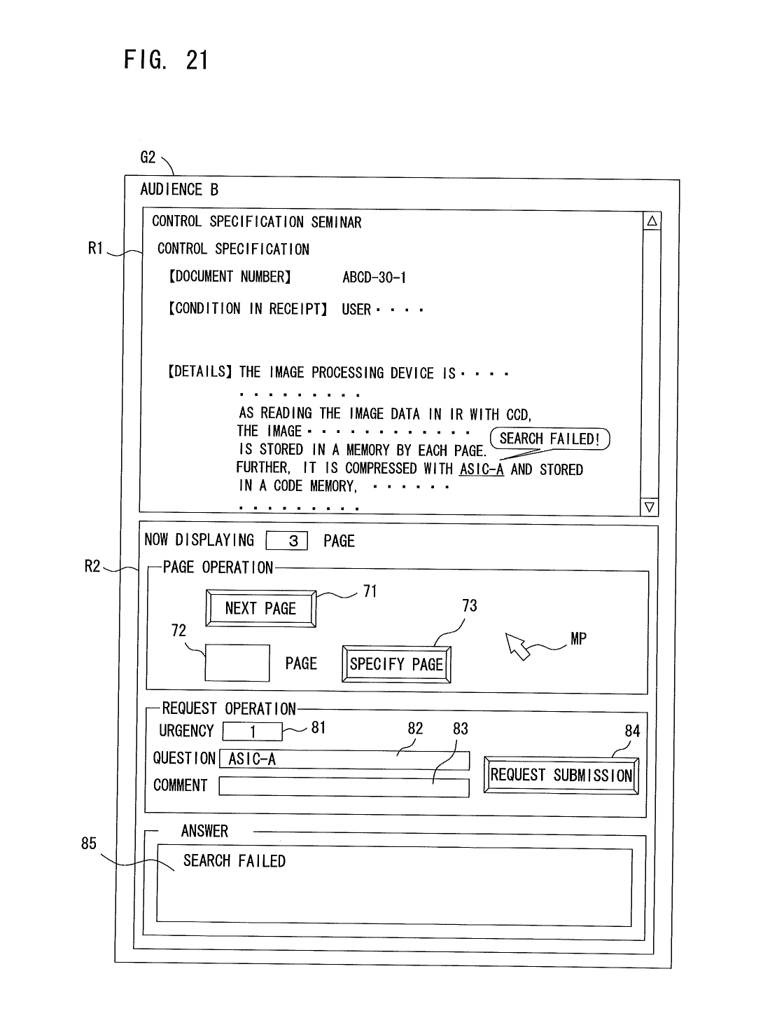

FIG. 21 shows an example of the operation screen G2 displayed on the information processing terminal 4b of the audience B. The presentation data of FIG. 5 is displayed in the data display region R1 of the operation screen G2 of FIG. 21. It is assumed that the “ASIC-A” is entered in the question entry field 82 of the request operation field and the request submission button 84 is clicked after specifying “level 1” in the urgency entry field 81 by the audience B to look up the meaning of the term “ASIC-A” while the data is displayed. In this case, the presentation execution part 32 executes the first search to obtain the answer corresponding to the “ASIC-A” from the answer to question information 65 shown in FIG. 6. As the keyword corresponding to the “ASIC-A”, however, is not registered in the answer to question information 65, the answer may not be obtained. The presentation execution part 32 executes the second search. The presentation execution part 32 extracts the keyword “image reading control” by referring to the search filter information 66, and outputs the search command combining the “ASIC-A” and the “image reading control” with the AND condition to the search device 11. No keyword corresponding to the “ASIC-A” is registered in the database 12 either, so the answer is not obtained. When the presentation execution part 32 may not obtain the answer corresponding to the “ASIC-A” even with the third and forth searches, the search results in failure. The presentation execution part 32 outputs the answer information showing that the search results in failure to the information processing terminal 4b. Thus, a message “search failed” is displayed in the answer field 85 as shown in FIG. 21. On the presentation data 63 displayed in the data display region R1, the character strings “ASIC-A” identified as the request area is underlined. Also, the answer information showing that the search results in failure is shown around the character strings. The audience B is still not allowed to understand the meaning of the term “ASIC-A.”

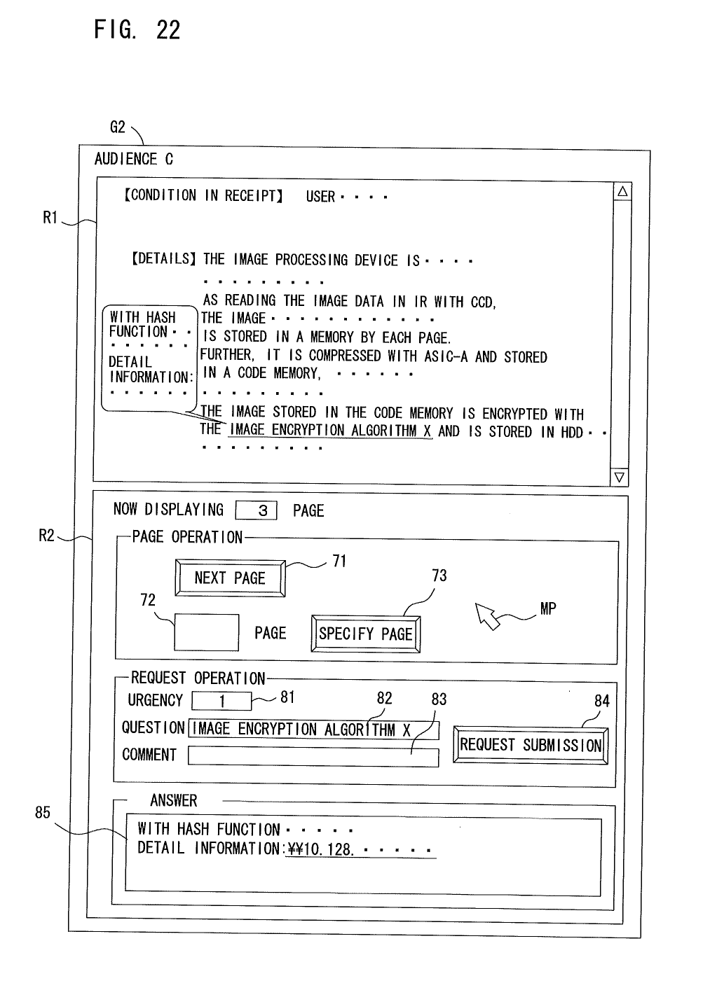

FIG. 22 shows an example of the operation screen G2 displayed on the information processing terminal 4c of the audience C. The presentation data of FIG. 5 is displayed in the data display region R1 of the operation screen G2 of FIG. 22. It is assumed that the “image encryption algorithm X” is entered in the question entry field 82 of the request operation field and the request submission button 84 is clicked after specifying “level 1” in the urgency entry field 81 by the audience C to look up the meaning of the term “image encryption algorithm X” while the data is displayed. In this case, the presentation execution part 32 executes the first search to obtain the answer corresponding to the “image encryption algorithm X” from the answer to question information 65 shown in FIG. 6. As the keyword corresponding to the “image encryption algorithm X,” however, is not registered in the answer to question information 65, the answer may not be obtained. The presentation execution part 32 executes the second search. The presentation execution part 32 extracts the keyword “image reading control” by referring to the search filter information 66, and outputs the search command combining the “image encryption algorithm X” and the “image reading control” with the AND condition to the search device 11. The search device 11 searches the database 12 by narrowing the theme down to “image reading control.” One answer corresponding to the “image encryption algorithm X” is then obtained. The search device 11 outputs the one answer to the presentation execution part 32. After obtaining the answer from the search device 11, the presentation execution part 32 generates the answer information based on the answer. By referring to FIG. 8, the answer corresponding to the keyword “image encryption algorithm X” contains the confidential information. It is determined whether or not to output the answer information thereby generated based on the authority information 69 of the audience C. To be more specific, when “high” is defined in the authority information 69 of the audience C, the answer information is output to the information processing terminal 4c. Whereas “low” is defined, the answer information is not output. If “high” is defined in the authority information 69 of the audience C in this case, the presentation execution part 32 outputs the answer information to the information processing terminal 4c. Thus, the answer extracted from the database 12 is displayed in the answer field 85 displayed on the screen of the information processing terminal 4c as shown in FIG. 22. On the presentation data 63 displayed in the data display region R1, the character strings “image encryption algorithm X” identified as the request area is underlined. Also, the answer information showing that the search results in failure is shown around the character strings. The audience C is allowed to understand the meaning of the term “image encryption algorithm X.”

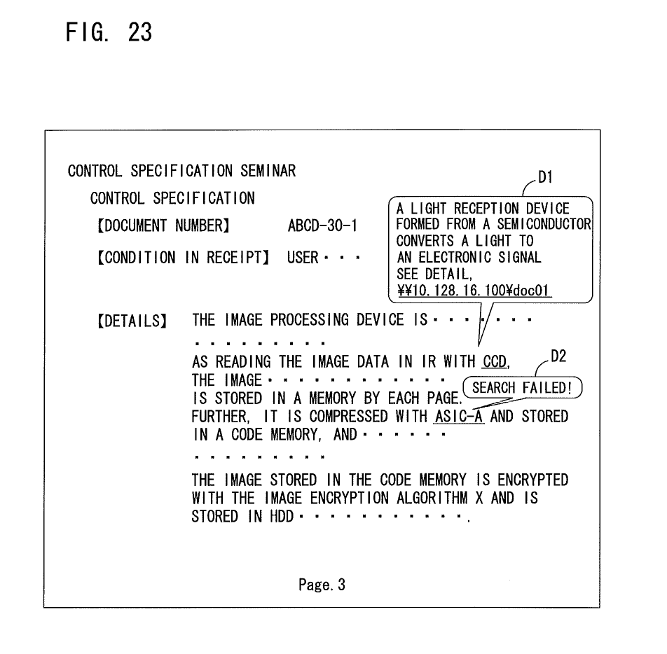

How the question and answer is reflected to the presentation data 62 projected on the screen 7 after the question described above is sent by each audience A, B and C is explained next. FIG. 23 shows an example of the presentation data 62 to which the request and the answer from each audience A, B and C is reflected. As described above, the audience A sends the question asking the term “CCD,” the audience B sends the question asking the term “ASIC-A,” and the audience C sends the question asking the term “image encryption algorithm X.” In this case, only the information does not contain the confidential information is shown on the presentation data 62, the shared data. To be more specific, the answer information obtained in response to the question asked by the audience A does not contain the confidential information, so that the answer is shown on the presentation data 62. Further, the answer information obtained in response to the question asked by the audience B does not contain the confidential information either, because the answer information shows that the search results in failure, so the answer is shown on the presentation data 62. The answer information obtained in response to the question asked by the audience C, however, contains the confidential information, so the answer is not shown on the presentation data 62. Therefore, the presentation data 62 as shown in FIG. 23 is output to the projector 5 by the presentation execution part 32 and projected on the screen 7 by the projector 5. More in detail, the presentation data 62 shows answer information Dl around the character strings “CCD,” and answer information D2 stating that the search results in failure around the character strings “ASIC-A.” The presentation data 62 including such information is projected on the screen 7. The audiences B and C, for example, are allowed to share the answer information D1 regarding “CCD” asked by the audience A, so they don't need to ask the same question. Furthermore, the presenter is allowed to give the supplementary explanation regarding the term “ASIC-A” at the appropriate timing, the search of which results in failure.

As described above, the presentation support device 2 of the present preferred embodiment is capable of performing data communication with each of the first information processing terminal 3 operable for the presenter, the second information processing terminal 4 operable for the each audience seeing and listening to the presentation by the presenter and the projector 5 projects the presentation data. The presentation support device 2 reads the presentation data in the storage device 24 and causes the projector 5 to project in response to the instruction received from the first information processing terminal 3. Further, the presentation support device 2 reads the presentation data in the storage device 24 and outputs to the second information processing terminal 4 in response to the instruction received from the first information processing terminal 3, thereby causing the second information processing terminal 4 to display the presentation data. The presentation support device 2 automatically obtains the answer to the question and generates the answer information based on the question on the presentation by the audience received from the second information processing terminal 4.

In response to the receipt of the request on question, the presentation support device 2 of the present preferred embodiment reads the answer to question information 65 in the storage device 24 and determines whether or not the keyword matching the search keyword contained in the request on question is registered in the answer to question information 65. When the keyword matching the search keyword is registered, the answer corresponding to the search keyword is obtained from the answer to question information 65 and generates the answer information. The question and answer prepared in advance by the presenter are associated with each other and registered in the answer to question information 65. So, the answer information obtained as described above is suitable on the content of the presentation. The audience is allowed to have the answer suitable on the content of the presentation easily in a short time by entering and sending the question on the content of the presentation during the presentation. So, the depth of the audience's understanding of the presentation may effectively be increased.

As receiving the request on question from the second information processing terminal 4, the presentation support device 2 of the present preferred embodiment reads the search filter information 66 in the storage device 24. Further, the presentation support device 2 reads the keyword registered in the search filter information 66 and searches the database 12 by the combination of the keyword and the search keyword contained in the request on question. The presentation support device 2 obtains the answer to the question and generates the answer information. The search filter information 66 is information in which the keyword as to the content of the page of the presentation data is set in advance by the presenter for each page included in the presentation data. The audience is allowed to have the answer suitable on the content of the presentation easily in a short time by entering and sending the question on the content of the presentation during the presentation. So, the depth of the audience's understanding of the presentation may effectively be increased.

As the answer corresponding to the search keyword is not obtained from the answer to question information 65, the presentation support device 2 of the present preferred embodiment reads the keyword registered in the search filter information 66 and searches the database 12 by the combination of the keyword and the search keyword. The presentation support device 2 obtains the answer to the question and generates the answer information. Even when the question asked by the audience is different from the question prepared in advance by the presenter, the answer information suitable on the content of the presentation is generated and provided to the audience.

As the answer corresponding to the search keyword is not obtained from the answer to question information 65, the presentation support device 2 of the present preferred embodiment may obtain the answer to the question and generate the answer information by referring to the search history information 29. In this case, the answer may be obtained effectively.

In generation of the answer information to the question asked by the audience, the presentation support device 2 determines whether or not the confidential information is contained in the generated answer information. When the confidential information is contained, the presentation support device 2 determines whether or not to provide the answer information containing the confidential information based on the authority information 69 of the audience. So, the confidential information is prevented from being disclosed to the audience who is not authorized to access the confidential information.

The presentation support device 2 of the present preferred embodiment allows the presenter and each audience to share the information with each other during the presentation. The share of the information may increase the depth of understanding of each audience in the presentation, while at the same time the presenter is allowed to give the effective presentation.

### Modifications

While the present preferred embodiment of the present invention has been described above, the present invention is not limited to the present preferred embodiment. Various modifications may be applied to the present invention.

In the above-described present preferred embodiment, the information device 10 shown to be a device such as MFPs realizes the main functions of the presentation support device 2. The functions of the information device 10 as described above may be realized, for example, by a general computer.

What is claimed is:

1. A presentation support device capable of performing data communication with each of a first information processing terminal operable for a presenter, a second information processing terminal operable for an audience who sees and listens to a presentation by the presenter and a projector projects presentation data, comprising:
a storage part for storing therein the presentation data created in advance by the presenter and search filter information in which a keyword to specify the content of the presentation is registered;
a data projection part for reading the presentation data in said storage part and outputting the read presentation data to said projector in response to an instruction received from said first information processing terminal, thereby causing said projector to project the presentation data;
a data distribution part for causing said second information processing terminal to display the presentation data by reading the presentation data in said storage part and outputting the read presentation data to said second information processing terminal; and
an answer generation part for obtaining an answer to a request on question toward the presentation asked by the audience and generating answer information in response to said request on question received from said second information processing terminal, wherein
said answer generation part reads the keyword registered in said search filter information and searches a predetermined database by a combination of the read keyword and a search keyword contained in said request on question, thereby obtaining the answer to said request on question and generating the answer information when said request on question is received from said second information processing terminal.

2. A presentation support device capable of performing data communication with each of a first information processing terminal operable for a presenter, a second information processing terminal operable for an audience who sees and listens to a presentation by the presenter and a projector projects presentation data, comprising:
a storage part for storing therein the presentation data created in advance by the presenter and answer to question information in which a keyword created in advance by the presenter and an answer corresponding to the keyword associated with each other are registered;
a data projection part for reading the presentation data in said storage part and outputting the read presentation data to said projector in response to an instruction received from said first information processing terminal, thereby causing said projector to project the presentation data;
a data distribution part for causing said second information processing terminal to display the presentation data by reading the presentation data in said storage part and outputting the read presentation data to said second information processing terminal; and
an answer generation part for obtaining an answer to a request on question toward the presentation asked by the audience and generating answer information in response to said request on question received from said second information processing terminal, wherein
said answer generation part reads said answer to question information and determines whether or not the keyword matching a search keyword contained in said request on question is registered in said answer to question information when said request on question is received from said second information processing terminal, and obtains the answer corresponding to the search keyword from said answer to question information and generates the answer information as the keyword matching the search keyword is registered.

3. The presentation support device according to claim 2, wherein
said storage part further stores therein search filter information in which a keyword to specify the content of the presentation is registered, and
said answer generation part reads the keyword registered in said search filter information and searches a predetermined database by a combination of the read keyword and the search keyword, thereby obtaining the answer to said request on question and generating the answer information when the answer corresponding to the search keyword is not obtained from said answer to question information.

4. The presentation support device according to claim 2, wherein
said storage part further stores search history information in which a search result obtained by a search through said database is recorded, and
said answer generation part obtains the answer to said request on question and generates the answer information by referring to said search history information when the answer corresponding to the search keyword is not obtained from said answer to question information.

5. The presentation support device according to claim 1, wherein
said answer generation part determines, to generate the answer information responding to said request on question in response to receipt of said request on question from said second information processing terminal operated by the audience, whether or not confidential information is contained in the answer information and determines whether or not to provide the answer information containing the confidential information based on authority information of the audience when the confidential information is contained.

6. The presentation support device according to claim 1, wherein
said data distribution part outputs the answer information generated by said answer generation part to said second information processing terminal.

7. The presentation support device according to claim 1, further comprising;
an answer reflection part for reflecting the answer information generated by said answer generation part to the presentation data, wherein
said data projection part outputs the presentation data to which the answer information is reflected by said answer reflection part to said projector, thereby causing said projector to project the presentation data to which the answer information is reflected.

8. The presentation support device according to claim 2, wherein
said answer generation part determines, to generate the answer information responding to said request on question in response to receipt of said request on question from said second information processing terminal operated by the audience, whether or not the confidential information is contained in the answer information and determines whether or not to provide the answer information containing the confidential information based on the authority information of the audience when the confidential information is contained.

9. The presentation support device according to claim 2, wherein said data distribution part outputs the answer information generated by said answer generation part to said second information processing terminal.

10. The presentation support device according to claim 2, further comprising;
an answer reflection part for reflecting the answer information generated by said answer generation part to the presentation data, wherein
said data projection part outputs the presentation data to which the answer information is reflected by said answer reflection part to said projector, thereby causing said projector to project the presentation data to which the answer information is reflected.

11. A computer readable medium on which a program is recorded, said program executed by a computer capable of performing data communication with each of a first information processing terminal operable for a presenter, a second information processing terminal operable for an audience who sees and listens to a presentation by the presenter and a projector projects presentation data, said program causing said computer to operate as a system comprising:
a presentation registration part for registering the presentation data created in advance by the presenter and search filter information in which a keyword to specify the content of the presentation is recorded in a predetermined storage part;
a data projection part for reading the presentation data in said storage part and outputting the read presentation data to said projector in response to an instruction received from said first information processing terminal, thereby causing said projector to project the presentation data;
a data distribution part for causing said second information processing terminal to display the presentation data by reading the presentation data in said storage part and outputting the read presentation data to said second information processing terminal; and
an answer generation part for obtaining an answer to a request on question toward the presentation asked by the audience and generating answer information in response to said request on question received from said second information processing terminal, wherein
said answer generation part reads the keyword registered in said search filter information and searches a predetermined database by a combination of the read keyword and a search keyword contained in said request on question, thereby obtaining the answer to said request on question and generating the answer information when said request on question is received from said second information processing terminal.

12. A computer readable medium on which a program is recorded, said program executed by a computer capable of performing data communication with each of a first information processing terminal operable for a presenter, a second information processing terminal operable for an audience who sees and listens to a presentation by the presenter and a projector projects presentation data, said program causing said computer to operate as a system comprising:
a presentation registration part for registering the presentation data created in advance by the presenter and answer to question information in which a keyword created in advance by the presenter and an answer corresponding to the keyword associated with each other are recorded in a predetermine storage part;
a data projection part for reading the presentation data in said storage part and outputting the read presentation data to said projector in response to an instruction received from said first information processing terminal, thereby causing said projector to project the presentation data;
a data distribution part for causing said second information processing terminal to display the presentation data by reading the presentation data in said storage part and outputting the read presentation data to said second information processing terminal; and
an answer generation part for obtaining an answer to a request on question toward the presentation asked by the audience and generating answer information in response to said request on question received from said second information processing terminal, wherein
said answer generation part reads said answer to question information and determines whether or not the keyword matching a search keyword contained in said request on question is registered in said answer to question information when said request on question is received from said second information processing terminal, and obtains the answer corresponding to the search keyword from said answer to question information and generates the answer information if the keyword matching the search keyword is registered.

13. The computer readable medium according to claim 12, wherein
said presentation registration part further registers search filter information in which a keyword to specify the content of the presentation is registered in said storage part, and
said answer generation part reads the keyword registered in said search filter information and searches a predetermined database by a combination of the read keyword and the search keyword, thereby obtaining the answer to said request on question and generating the answer information when the answer corresponding to the search keyword is not obtained from said answer to question information.

14. The computer readable medium according to claim 12, wherein
said answer generation part stores search history information in which a search result obtained by a search through said database is recorded in said storage part, thereafter, obtains the answer to said request on question and generates the answer information by referring to said search history information when the answer corresponding to the search keyword is not obtained from said answer to question information.

15. The computer readable medium according to claim 11, wherein
said answer generation part determines, to generate the answer information responding to said request on question in response to receipt of said request on question from said second information processing terminal operated by the audience, whether or not confidential information is contained in the answer information and determines whether or not to provide the answer information containing the confidential information based on authority information of the audience when the confidential information is contained.

16. The computer readable medium according to claim 11, wherein
said data distribution part outputs the answer information generated by said answer generation part to said second information processing terminal.

17. The computer readable medium according to claim 11, wherein said program causes said computer to operate as a system further comprising:
an answer reflection part for reflecting the answer information generated by said answer generation part to the presentation data, and
said data projection part outputs the presentation data to which the answer information is reflected by said answer reflection part to said projector, thereby causing said projector to project the presentation data to which the answer information is reflected.

18. The computer readable medium according to claim 12, wherein
said answer generation part determines, to generate the answer information responding to said request on question in response to receipt of said request on question from said second information processing terminal operated by the audience, whether or not the confidential information is contained in the answer information and determines whether or not to provide the answer information containing the confidential information based on the authority information of the audience when the confidential information is contained.

19. The computer readable medium according to claim 12, wherein
said data distribution part outputs the answer information generated by said answer generation part to said second information processing terminal.

20. The computer readable medium according to claim 12, wherein said program causes said computer to operate as a system further comprising:
an answer reflection part for reflecting the answer information generated by said answer generation part to the presentation data, and
said data projection part outputs the presentation data to which the answer information is reflected by said answer reflection part to said projector, thereby causing said projector to project the presentation data to which the answer information is reflected.
